(19) United States
(12) Patent Application Publication
(10) Pub. No.: US 2023/0258347 A1
(43) Pub. Date: Aug. 17, 2023

(54) Estimates of Cooling or Heating Power

(71) Applicant: Siemens Schweiz AG, Zürich (CH)

(72) Inventors: Benedikt Schumacher, Wetzikon (CH); Tiziano Di Pietro, Agarone (CH); Bettina Maurer, Spiez (CH)

(73) Assignee: Siemens Schweiz AG, Zürich (CH)

(21) Appl. No.: 18/168,885

(22) Filed: Feb. 14, 2023

(30) Foreign Application Priority Data
Feb. 15, 2022 (EP) 22156770.4

(51) Int. Cl. F24F 11/30; F24F 11/65; F24F 11/58

(52) U.S. Cl. CPC F24F 11/30; F24F 11/65; F24F 11/58; F24F 2110/12

(57) ABSTRACT

Various embodiments of the teachings herein include methods of estimating a heat transfer via one or more thermal energy exchangers. An example method includes: acquiring a signal for a setpoint temperature; acquiring a signal for an inside temperature at a site; acquiring one or more signals indicative of positions of valves of the thermal energy exchangers; producing a value of setpoint temperature from the signal; producing a value of inside temperature; producing a value of position from the one or more signals; providing a calibrated model with the value of setpoint temperature and inside temperature and position; and using the calibrated model to estimate the heat transfer via the one or more thermal energy exchangers.

### CROSS-REFERENCE TO RELATED APPLICATIONS

This application claims priority to EP Application No. 22156770.4 filed Feb. 15, 2022, the contents of which are hereby incorporated by reference in their entirety.

### TECHNICAL FIELD

The present disclosure generally relates to heating and/or cooling systems. Various embodiments of the teachings herein include methods and/or systems for estimating and/or determining an amount of power required for cooling or heating a site.

### BACKGROUND

Installations for heating and/or ventilation, and/or air-conditioning (HVAC) are commonly made up of a plurality of circuits. Each circuit comprises one or several thermal energy exchangers to provide heating and/or cooling to various parts of a building. Thermal energy exchangers can be heating devices and/or cooling devices. A thermal energy exchanger of a domestic heating system can be a heat exchanger such as a radiator.

Energy management systems and/or power management systems can control thermal loads of a site. More specifically, energy management systems and/or power management systems can control cooling and/or heating within a building. The building can, by way of non-limiting example, be a commercial and/or an industrial and/or a residential building.

Buildings can employ hot-water tanks to store thermal energy such as heat. Likewise, cold-water storage tanks can be employed as buffers for coolants such as water. Also, storage ovens can store thermal energy to be released during the day. These examples of storage devices are not exhaustive.

To minimize waste of power and to inhibit emissions of carbon dioxide, a daily amount of cooling power and/or of heating power shall be estimated in advance. Any deviation of such estimates from actual demand can result in an oversupply or in an undersupply of thermal power. If too much thermal energy is stored in a storage tank, an amount of power will be lost due to the excessive supply. If too little thermal energy is stored, a cooling and/or heating system may need to activate during the day and fill a gap between supply and demand.

Also, occupants and operators of buildings are increasingly aware of the technical aspects of their use of thermal power. Occupants and operators are also increasingly aware of emissions of carbon dioxide caused by their use of thermal power. Operators can, by way of non-limiting example, investigate defects within a system for heating and/or ventilation and/or air-conditioning, if their use of thermal power beats expectations. Occupants also seek to minimize any environmental impacts of their cooling and/or heating. Those environmental impacts include, but are not limited to, emissions of carbon dioxide.

That said, an estimate of the actual use of thermal power can depend on a plethora of factors. These factors include, but are not limited to:
supply temperatures of thermal energy exchangers,
return temperatures of thermal energy exchangers,
valve positions at such thermal energy exchangers,
setpoint temperatures for such thermal energy exchangers,
room temperatures, and/or
outside temperatures.

Certain factors such as outside temperatures may not be readily available. A lack of a sensor for outside temperature may, by way of non-limiting example, exacerbate the problem of adequately estimating outside temperatures. The problem is further aggravated because buildings differ in their amounts of thermal insulation and/or in the type of heating system installed. Buildings may also differ in the efficiencies of their thermal energy exchangers. This list of differences between buildings is by no means exhaustive.

It is thus far from certain whether one model can be applied to provide estimates of cooling power and/or of heating power that are at least fair. Even if there was such a model, it would not be trivial to limit the numbers of factors that impact on the results of such a model.

A patent application WO2015/061271A1 deals with low-frequency ancillary power grid services. WO2015/061271A1 discloses a high-fidelity model. The high-fidelity model is calibrated such that it can predict temperatures within one or more zones. For calibration, data are collected from a building having a plurality of zones. To mitigate influences of solar radiation or of occupant heat gains, these data are collected at nighttime.

The model of temperature resembles a resistive-capacitive network. It provides a plurality of interconnected resistive-capacitive network models for the individual zones of the building. The model predicts changes of temperatures over time for individual zones as a function of its capacitive and resistive parameters. A least-squares approach is used to fit parameters of the model.

### SUMMARY

The present disclosure deals with methods and/or devices for estimating a cooling power and/or a heating power. For example, some embodiments of the teachings herein include a method of estimating a heat transfer Q·(in,est) via one or more thermal energy exchangers (4-8), the method comprising the steps of: acquiring a signal indicative of a setpoint temperature; acquiring a signal indicative of an inside temperature at a site (2); acquiring one or more signals indicative of positions of valves of the one or more thermal energy exchangers (4-8); producing a value of setpoint temperature from the signal indicative of the setpoint temperature; producing a value of inside temperature T_site at the site (2) from the signal indicative of inside temperature; producing a value of position from the one or more signals indicative of positions of the valves; providing a calibrated model (11; 26) with the value of setpoint temperature and with the value of inside temperature T_site at the site (2) and with the value of position; and using the calibrated model (11; 26) to estimate the heat transfer Q·(in,est) via the one or more thermal energy exchangers (4-8).

In some embodiments, the method further comprises: using the calibrated model (11; 26) to normalise the value of setpoint temperature; using the calibrated model (11; 26) to normalise the value of inside temperature T_site at the site (2); using the calibrated model (11; 26) to normalise the value of position; and using the calibrated model (11; 26) to estimate the heat transfer Q·(in,est) via the one or more thermal energy exchangers (4-8) based on the normalised value of setpoint temperature and based on the normalised value of inside temperature at the site (2) and based on the normalised value of position.

In some embodiments, the method further comprises: producing one or more individual values by producing an individual value from each signal indicative of a position of a valve; and producing the value of position by determining a mean of the one or more individual values.

In some embodiments, the method further comprises using the calibrated model (11) to estimate the heat transfer Q·(in,est) via the one or more thermal energy exchangers (4-8) exclusively as a function of the normalised value of setpoint temperature and of the normalised value of inside temperature at the site (2) and of the normalised value of position.

In some embodiments, the method further comprises: acquiring a signal indicative of an outside temperature outside the site (2); producing a value of outside temperature T_out from the signal indicative of outside temperature; providing the calibrated model (26) with the value of setpoint temperature and with the value of inside temperature T_site at the site (2) and with the value of position and with the value of outside temperature T_out; and using the calibrated model (26) to estimate the heat transfer Q·(in,est) via the one or more thermal energy exchangers (4-8) based on the value of setpoint temperature and based on the value of inside temperature T_site at the site (2) and based on the value of position and based on the value of outside temperature T_out.

In some embodiments, the method further comprises acquiring the signal indicative of the outside temperature outside the site (2) by reading the signal indicative of outside temperature from a sensor outside the site (2).

In some embodiments, the method further comprises acquiring the signal indicative of the outside temperature outside the site (2) by connecting to a computer network and by receiving from the network a data package comprising the signal indicative of the outside temperature and by extracting the signal indicative of the outside temperature from the data package.

In some embodiments, the method further comprises: using the calibrated model (26) to normalise the value of setpoint temperature; using the calibrated model (26) to normalise the value of inside temperature T_site at the site (2); using the calibrated model (26) to normalise the value of position; using the calibrated model (26) to normalise the value of outside temperature T_out; and using the calibrated model (26) to estimate the heat transfer Q·(in,est) via the one or more thermal energy exchangers (4-8) based on the normalised value of setpoint temperature and based on the normalised value of inside temperature at the site (2) and based on the normalised value of position and based on the normalised value of outside temperature.

In some embodiments, the method further comprises using the calibrated model (26) to estimate the heat transfer Q·(in,est) via the one or more thermal energy exchangers (4-8) exclusively as a function of the value of setpoint temperature and of the value of inside temperature T_site at the site (2) and of the value of position and of the value of outside temperature T_out.

In some embodiments, the method further comprises using the calibrated model (26) to estimate the heat transfer Q·(in,est) via the one or more thermal energy exchangers (4-8) exclusively as a function of the normalised value of setpoint temperature and of the normalised value of inside temperature at the site (2) and of the normalised value of position and of the normalised value of outside temperature.

In some embodiments, the method further comprises: comparing the estimated heat transfer Q·(in,est) to an upper threshold; and, if the estimated heat transfer Q·(in,est) is larger than the upper threshold, operating an electric switch to curtail power to a system for heating and/or ventilation and/or air-conditioning (1).

In some embodiments, the electric switch connects the system for heating and/or ventilation and/or air-conditioning (1) to a power grid, the method further comprises, if the estimated heat transfer Q·(in,est) is larger than the upper threshold, disconnecting the system for heating and/or ventilation and/or air-conditioning (1) from the power grid by operating the electric switch.

As another example, some embodiments include a device comprising: a first interface for acquiring a signal indicative of a setpoint temperature, a second interface for acquiring a signal indicative of an inside temperature at a site (2), a third interface for acquiring one or more signals indicative of positions of valves of one or more thermal energy exchangers (4-8), a memory and a processor in operative communication with the memory, with the first interface, with the second interface, and with the third interface, the processor being configured to: read a calibrated model (11; 26) from the memory; and perform one or more of the methods described herein.

As another example, some embodiments include a computer program comprising a set of instructions that when executed by one or more processors cause a device to perform one or more of the methods described herein.

As another example, some embodiments include a computer-readable medium having stored thereon a computer program as described herein.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 schematically shows various terminal units and a system controller of a heating and/or ventilation and/or air-conditioning system incorporating teachings of the present disclosure;

FIG. 2 is a schematical representation of flows of power into and out of a site incorporating teachings of the present disclosure;

FIG. 3 illustrates a first neural network for estimating cooling and/or heating power incorporating teachings of the present disclosure; and

FIG. 4 illustrates a second neural network for estimating cooling and/or heating power incorporating teachings of the present disclosure.

### DETAILED DESCRIPTION

In various embodiments of the teachings herein, a “cooling power” and/or a “heating power” is a cooling power and/or heating power dissipated via a terminal unit such as a thermal energy exchanger. To that end, various input signals are collected. A setpoint temperature is an input signal. A temperature inside a site and/or a building and/or a zone and/or a space and/or a room forms another input signal. An indication of valve position is yet another input signal. The indication of valve position can, by way of non-limiting example, originate from a thermostat or from a smart thermostat. The indication of valve position can, by way of non-limiting example, originate from a system controller. These signals are processed. Values of setpoint temperature, of inside temperature, and of valve position are produced. A calibrated model such as a neural network receives the values at its input nodes. The calibrated model and/or the neural network then processes its inputs. The calibrated model and/or the neural network estimates a heat transfer in the form of a cooling power and/or a heating power via the terminal unit.

The methods and devices described herein may rely on a minimum of input parameters. The estimates produced by the calibrated model are fair with deviations from actual values being mostly less than twenty percent. In many cases, these estimates are even satisfactory. That is why the method, and the device are applicable to a plethora of sites and/or buildings.

The inputs of the calibrated model and/or of the neural network can be normalised. Normalisation of input values yields even more accurate estimates of heat transfer. More specifically, normalisation of input values yields more accurate estimates of cooling power and/or of heating power.

A site or a building can comprise a plurality of valves. In this case, it makes sense to determine a mean valve position. The mean valve position represents the valves in the building or at the site. More specifically, a weighted mean represents the valves in the building or at the site.

To further improve on the accuracy of the estimates, an outside temperature can be factored into the estimate. The outside temperature can, by way of example, be read from a sensor or be received from a weather station. A value of outside temperature is then produced from the signal indicative of outside temperature. The calibrated model receives an additional input, the additional input being the value of outside temperature. More specifically, the neural network receives an additional input, the additional input being the value of outside temperature. The calibrated model and/or the neural network additionally processes the value of outside temperature. The calibrated model and/or the neural network estimates a heat transfer in the form of a cooling power and/or a heating power via the terminal unit.

The value of outside temperature can also be normalised. Normalisation of outside temperature yields even more accurate estimates of heat transfer. More specifically, normalisation of outside temperature yields more accurate estimates of cooling power and/or of heating power.

Where the estimates are exclusively based on setpoint temperatures, inside temperatures, outside temperatures, and valve positions, the results are still generally applicable. The estimates can be applied to most sites or buildings since outside temperatures can be received from a service provider. In other words, a limited number of input values yields estimates of heat transfer that deviate from actual values mostly by less than twenty percent. Deviations can in many cases be kept below ten percent.

The outputs of the method and/or of the device can also be used to curtail power. It can become necessary to curtail power when the stability of the power grid is no longer guaranteed. A grid operator can then receive an estimate of cooling power and/or of heating power. The grid operator can then curtail power to a system for heating and/or ventilation and/or air-conditioning to maintain stability of the grid.

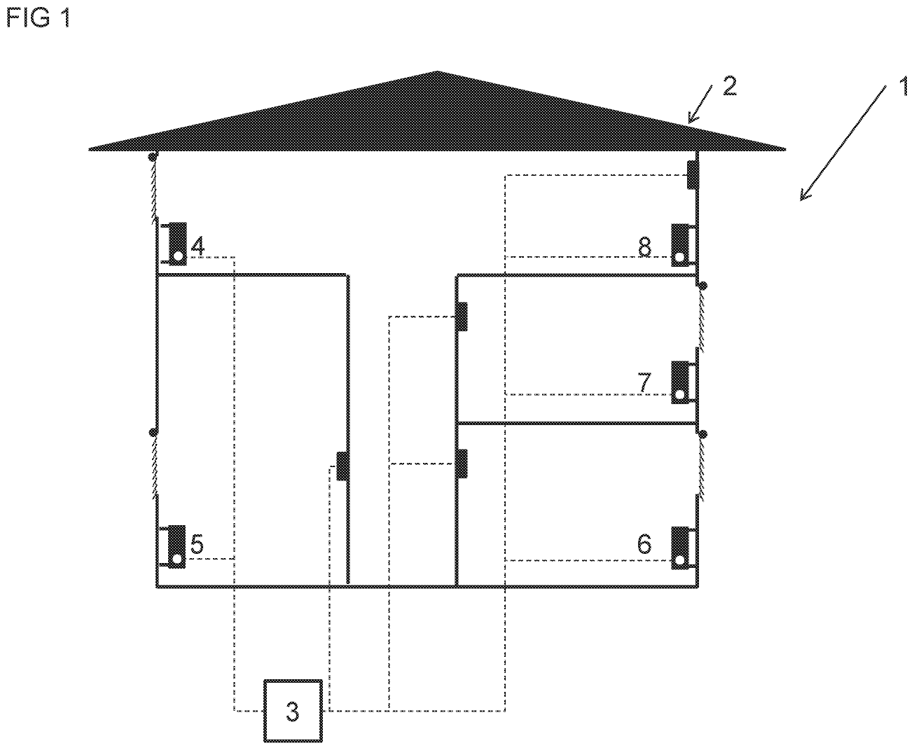

FIG. 1 shows a system for heating and/or ventilation and/or air-conditioning 1 incorporating teachings of the present disclosure. The system for heating and/or ventilation and/or air-conditioning 1 comprises a system controller 3. The system controller 3 can be arranged at a site 2 that is controlled by the system for heating and/or ventilation and/or air-conditioning 1. More specifically, the system controller 3 can be arranged inside a building 2 that is controlled by the system for heating and/or ventilation and/or air-conditioning 1.

The system controller 3 can also be located remotely from a site 2 that is controlled by the system for heating and/or ventilation and/or air-conditioning 1. More specifically, the system controller 3 can be located remotely from a building 2 that is controlled by the system for heating and/or ventilation and/or air-conditioning 1. The system controller 3 can, by way of non-limiting example, be located more than one kilometer from the site or from the building 2. The system controller 3 can, by way of another non-limiting example, be located more than ten kilometers from the site or from the building 2. The system controller 3 can, by way of yet another non-limiting example, be located more than one hundred kilometers from the site or from the building 2.

The system controller 3 comprises a power management system such as a power management system for the site 2. The system controller 3 ideally is a power management system such as a power management system for the site 2. More specifically, the system controller 3 can comprise a power management system for the building 2. The system controller 3 can also be a power management system for the building 2.

The system for heating and/or ventilation and/or air-conditioning 1 comprises at least one terminal unit 4-8. The system for heating and/or ventilation and/or air-conditioning 1 preferably comprises a plurality of terminal units 4-8. More specifically, a site 2 can comprise at least one terminal unit 4-8. In some embodiments, the site 2 comprises a plurality of terminal units 4-8. More specifically, a building 2 can comprise at least one terminal unit 4-8. The building 2 preferably comprises a plurality of terminal units 4-8.

At least one terminal unit 4-8 comprises a valve. The valve controls flow of a coolant and/or of a heating medium through the at least one terminal unit 4-8. According to an aspect of the system for heating and/or ventilation and/or air-conditioning 1, every terminal unit 4-8 comprises a valve. These valves control flows of a coolant and/or of a heating medium through their respective terminal units 4-8.

In some embodiments, one or more terminal units 4-8 comprise a heating device such as a radiator. In some embodiments, the one or more terminal units 4-8 comprise cooling devices such as chilled beams.

In some embodiments, the one or more terminal units 4-8 comprise one or more thermal energy exchangers. In some embodiments, the one or more terminal units 4-8 are one or more thermal energy exchangers.

One or more of the terminal units 4-8 comprise a valve having a valve controller. In some embodiments, the valve controller comprises a microcontroller and/or a microprocessor. In an embodiment, the valve controller is a microcontroller and/or is a microprocessor. In some embodiments, the valve controller comprises a memory such as a non-volatile memory.

In some embodiments, the valve controller comprises an inexpensive and/or low-power system-on-a-chip microcontroller having integrated wireless connectivity. In some embodiments, the system-on-a-chip microcontroller has a memory not exceeding one mebibyte. In some embodiments, the valve controller connects to an edge device.

In some embodiments, the one or more valve controllers of the one or more terminal units 4-8 can comprise thermostats such as smart thermostats. In some embodiments, the one or more valve controllers of the one or more terminal units 4-8 can also be thermostats. In some embodiments, the one or more valve controllers of the one or more terminal units can be smart thermostats.

In some embodiments, the one or more valve controllers of the one or more terminal units 4-8 comprise one or more analog-to-digital converters. The one or more analog-to-digital converters provide conversion of analog signals into (digital) values. The one or more analog-to-digital converters can, by way of non-limiting example, convert signals indicative of valve positions into (digital) values. The one or more analog-to-digital converters can, by way of another non-limiting example, convert signals originating from temperature sensors into (digital) values. It is envisaged that the signals originating from temperature sensors are signals indicative of supply temperatures and/or indicative of temperatures at the site 2. The signals originating from temperature sensors can also be signals indicative of temperatures outside the site 2.

The one or more analog-to-digital converters can be integral parts of the one or more valve controllers of the one or more terminal units 4-8. That is, there are systems-on-a-chip, each system-on-a-chip having an analog-to-digital converter and a valve controller.

In some embodiments, the one or more valve controllers of the one or more terminal units 4-8 comprise one or more sigma-delta converters. The one or more sigma-delta converters provide conversion of analog signals into (digital) values. The one or more sigma-delta converters can, by way of non-limiting example, convert signals indicative of valve positions into (digital) values. The one or more sigma-delta converters can, by way of another non-limiting example, convert signals originating from temperature sensors into (digital) values. In some embodiments, the signals originating from temperature sensors are signals indicative of supply temperatures and/or indicative of temperatures at the site 2. The signals originating from temperature sensors can also be signals indicative of temperatures outside the site 2.

In some embodiments, the one or more sigma-delta converters can be integral parts of the one or more valve controllers of the one or more terminal units 4-8. That is, there are systems-on-a-chip, each system-on-a-chip having a sigma-delta converter and a valve controller.

The valve controller is in operative communication with the system controller 3. A connection between the valve controller and the system controller 3 can be bidirectional. A bidirectional connection affords flexibility. A connection between the valve controller and the system controller 3 can also be unidirectional. Communication from the valve controller to the system controller 3 is facilitated by such a unidirectional connection. A unidirectional connection reduces complexity.

A communication link between the valve controller and the system controller 3 can, for example, rely on wireless solutions such as WLAN and/or KNX® RF. A communication link between the valve controller and the system controller 3 can, for example, also rely on wireless solutions such as Thread and/or Zigbee and/or EnOcean®. The wireless communication link preferably involves a digital communication bus. The wireless communication link preferably involves a digital communication protocol.

A communication link between the valve controller and the system controller 3 can, for example, also rely on hard-wired connections such as Ethernet® cables and/or on KNX® cables. The hard-wired communication link preferably involves a digital communication bus. The hard-wired communication link preferably involves a digital communication protocol.

In some embodiments, all the terminal units 4-8 comprise a valve having a valve controller. The valve controllers advantageously each comprise a microcontroller and/or a microprocessor. In an embodiment, the valve controllers are microcontrollers and/or microprocessors. In some embodiments, the valve controllers each comprise a memory such as a non-volatile memory.

In some embodiments, the valve controllers comprise inexpensive and/or low-power system-on-a-chip microcontrollers, each system-on-a-chip microcontroller having integrated wireless connectivity. In some embodiments, the system-on-a-chip microcontrollers each have a memory not exceeding one mebibyte.

In some embodiments, the valve controllers comprise analog-to-digital converters. The analog-to-digital converters provide conversion of analog signals into (digital) values. The analog-to-digital converters can, by way of non-limiting example, convert signals indicative of valve positions into (digital) values. The analog-to-digital converters can, by way of another non-limiting example, convert signals originating from temperature sensors into (digital) values. In some embodiments, the signals originating from temperature sensors are signals indicative of supply temperatures and/or indicative of temperatures at the site 2. The signals originating from temperature sensors can also be signals indicative of temperatures outside the site 2.

In some embodiments, the analog-to-digital converters can be integral parts of the valve controllers of the terminal units 4-8. That is, there are systems-on-a-chip, each system-on-a-chip having an analog-to-digital converter and a valve controller.

In some embodiments, the valve controllers comprise sigma-delta converters. The sigma-delta converters provide conversion of analog signals into (digital) values. The sigma-delta converters can, by way of non-limiting example, convert signals indicative of valve positions into (digital) values. The sigma-delta converters can, by way of another non-limiting example, convert signals originating from temperature sensors into (digital) values. It is envisaged that the signals originating from temperature sensors are signals indicative of supply temperatures and/or indicative of temperatures at the site 2. The signals originating from temperature sensors can also be signals indicative of temperatures outside the site 2.

In some embodiments, the sigma-delta converters can be integral parts of the valve controllers of the terminal units 4-8. That is, there are systems-on-a-chip, each system-on-a-chip having a sigma-delta converter and a valve controller. The valve controllers are in operative communication with the system controller 3. Connections between the valve controllers and the system controller 3 can be bidirectional. Bidirectional connections afford flexibility. Connections between the valve controller and the system controller 3 can also be unidirectional. Communication from the valve controllers to the system controller 3 is facilitated by such unidirectional connections. Unidirectional connections reduce complexity.

In some embodiments, the valve controllers connect to the system controller 3 in a hub and spoke topology. In some embodiments, a network having a mesh topology connects the valve controllers to the system controller 3. In some embodiments, the valve controllers and the system controller 3 form a full-mesh topology network.

A network comprising the valve controllers and the system controller 3 can, for example, rely on wireless solutions such as WLAN and/or KNX® RF and/or Thread. A network comprising the valve controllers and the system controller 3 can, for example, also rely on wireless solutions such as Zigbee, and/or EnOcean®. Any communication within the wireless network involves a digital communication bus. Any communication within the wireless network preferably involves a digital communication protocol.

A network comprising the valve controllers and the system controller 3 can, for example, also rely on hard-wired connections such as Ethernet® cables and/or on KNX® cables. Any communication within the hard-wired network preferably involves a digital communication bus. Any communication within the hard-wired network may involve a digital communication protocol.

In some embodiments, the system controller 3 can identify valve controllers of terminal units 4-8. Identification can, by way of example, take place based on machine addresses of such valve controllers. That is, the valve controllers and/or the memories of the valve controllers store such machine addresses. The system controller 3 will then use a lookup table to identify the controllers of the terminal units 4-8. Identification can, by way of another example, take place based on vendor identities and/or product identities of such valve controllers. That is, the valve controllers and/or the memories of the valve controllers store such vendor identities and/or product identities. Accordingly, the valve controllers send their vendor identities and/or product identities to the system controller 3 for identification purposes.

In some embodiments, the system controller 3 is operable to configure one or more of the valve controllers of the terminal units 4-8. In so doing, the system controller 3 can provide the one or more valve controllers data such as baud rates and/or logical addresses. The system controller 3 can also provide the one or more valve controllers data such as setpoints of room temperature. The system controller 3 can further provide the one or more valve controllers data such as setpoints of temperature within a zone.

Where the valve controllers are battery-operated, the valve controllers may be operable to receive signals indicative of the charging levels of their respective batteries. The valve controllers then produce values of charging levels based on these signals. Where a charging level is less than a threshold such as a predefined threshold, a low-battery alarm signal can be sent to the system controller 3.

In some embodiments, the system controller 3 comprises one or more analog-to-digital converters. The one or more analog-to-digital converters provide conversion of analog signals into (digital) values. The one or more analog-to-digital converters can, by way of non-limiting example, convert signals indicative of valve positions into (digital) values. The one or more analog-to-digital converters can, by way of another non-limiting example, convert signals originating from temperature sensors into (digital) values. In some embodiments, the signals originating from temperature sensors are signals indicative of supply temperatures and/or indicative of temperatures at the site 2. The signals originating from temperature sensors can also be signals indicative of temperatures outside the site 2.

In some embodiments, the one or more analog-to-digital converters can be integral parts of the system controller 3 of the terminal units 4-8. That is, there is a systems-on-a-chip having one or more analog-to-digital converters and the system controller 3.

In some embodiments, the system controller 3 comprises one or more sigma-delta converters. The one or more sigma-delta converters provide conversion of analog signals into (digital) values. The one or more sigma-delta converters can, by way of non-limiting example, convert signals indicative of valve positions into (digital) values. The one or more sigma-delta converters can, by way of another non-limiting example, convert signals originating from temperature sensors into (digital) values. It is envisaged that the signals originating from temperature sensors are signals indicative of supply temperatures and/or indicative of temperatures at the site 2. In some embodiments, the signals originating from temperature sensors can also be signals indicative of temperatures outside the site 2.

In some embodiments, the one or more sigma-delta converters can be integral parts of the system controller 3 of the terminal units 4-8. That is, there is a systems-on-a-chip having one or more sigma-delta converters and the system controller 3.

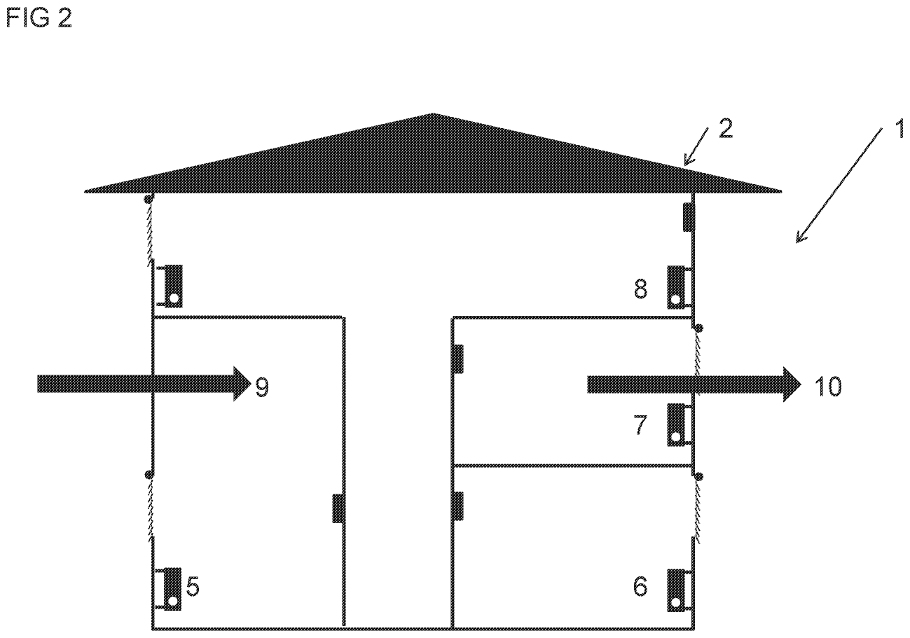

Now turning to FIG. 2, an arrow 9 indicative of power intake of the site 2 and an arrow 10 indicative of power losses of the site 2 are shown. More specifically, FIG. 2 illustrates flows of power 9, 10 into and out of a building 2.

The power intake of the site 2 depends on the one or more positions of the one or more valves of the terminal units 4-8. More specifically, the intake of the building 2 depends on the one or more positions of the one or more valves of the terminal units 4-8. The intake of the site 2 also depends on a setpoint temperature.

The one or more positions of the one or more valves of the terminal units 4-8 are readily available by way of measurements. The one or more positions of the one or more valves of the terminal units 4-8 can also be derived from one or more control signals. The control signals can, by way of non-limiting example, be produced and transmitted by the system controller 3. The control signals can, by of another non-limiting example, also be produced and transmitted by the one or more valve controllers of the terminal units 4-8. The control signals can, by of another non-limiting example, also be produced and transmitted by one or more thermostats of the system 1. More specifically, the control signals can be produced and transmitted by one or more thermostats of the site 2. The control signals can still be produced and transmitted by one or more thermostats of the building 2.

The one or more supply temperatures of the one or more valves of the terminal units 4-8 are readily available by way of measurements. To that end, one or more valves of the terminal units 4-8 can comprise one or more temperature sensors such as one or more thermocouples. The one or more temperature sensors are typically arranged in communication with the supply ends of the one or more valves. The one or more temperature sensors are preferably arranged in direct communication with the supply ends of the one or more valves.

The one or more supply temperatures of the one or more terminal units 4-8 can also be readily available by way of measurements. To that end, the one or more terminal units 4-8 can comprise one or more temperature sensors such as one or more thermocouples. The one or more temperature sensors are typically arranged in communication with the supply ends of the one or more terminal units 4-8. The one or more temperature sensors are preferably arranged in direct communication with the supply ends of the one or more terminal units 4-8.

By contrast, the power intake \dot{Q}ᵢₙ of the site 2 is in many cases not readily available by way of measurements. Instead, the power intake \dot{Q}ᵢₙ of the site 2 needs be estimated based on quantities such as the one or more valve positions. The power intake \dot{Q}ᵢₙ of the site 2 can also be estimated based on quantities such as a setpoint temperature. The power intake \dot{Q}ᵢₙ can be estimated based on the one or more valve positions and based on a setpoint temperature.

More specifically, the power intake \dot{Q}ᵢₙ of the building 2 is in many cases not readily available by way of measurements. Instead, the power intake \dot{Q}ᵢₙ of the building 2 needs be estimated based on quantities such as the one or more valve positions. The power intake \dot{Q}ᵢₙ of the building 2 can also be estimated based on quantities such as a setpoint temperature. The power intake \dot{Q}ᵢₙ can be estimated based on the one or more valve positions and based on a setpoint temperature.

Likewise, the power losses \dot{Q}ₒᵤₜ of the site 2 are in many cases not readily available by way of measurements. Instead, the power losses \dot{Q}ₒᵤₜ of the site 2 need be estimated based on quantities such as the outside temperature. The power losses \dot{Q}ₒᵤₜ of the site 2 can also be estimated based on quantities such as one or more values of room temperature. The one or more values of room temperature are typically room temperatures of one or more zones within the site 2. The one or more values of room temperature can also be room temperatures of one or more spaces within the site 2. The one or more values of room temperature can also be room temperatures of one or more rooms within the site 2.

The power losses \dot{Q}ₒᵤₜ of the building 2 are in many cases not readily available by way of measurements. Instead, the power losses \dot{Q}ₒᵤₜ of the building 2 need be estimated based on quantities such as the outside temperature. The power losses \dot{Q}ₒᵤₜ of the building 2 can also be estimated based on quantities such as one or more values of room temperature. The one or more values of room temperature are typically room temperatures of one or more zones within the building 2. The one or more values of room temperature can also be room temperatures of one or more spaces within the building 2. The one or more values of room temperature can also be room temperatures of one or more rooms within the building 2.

The power losses \dot{Q}ₒᵤₜ of the site 2 can also be estimated based on one or more setpoints of temperature. The one or more setpoints of temperature can, by way of non-limiting example, be produced and transmitted by the system controller 3. The setpoints can, by of another non-limiting example, also be produced and transmitted by the one or more valve controllers of the terminal units 4-8. The one or more setpoints can, by of another non-limiting example, also be produced and transmitted by one or more thermostats of the system 1. More specifically, the one or more setpoints of temperature can be produced and transmitted by one or more thermostats of the site 2. The one or more setpoints of temperature can still be produced and transmitted by one or more thermostats of the building 2.

In some embodiments, the power losses \dot{Q}ₒᵤₜ of the site 2 are estimated based on outside temperature and based on values of room temperature. The power losses \dot{Q}ₒᵤₜ of the site 2 can also be determined based on outside temperature and based on values of room temperature. The power losses \dot{Q}ₒᵤₜ of the site 2 can still be calculated based on outside temperature and based on values of room temperature.

More specifically, the power losses \dot{Q}ₒᵤₜ of the building 2 are estimated based on outside temperature and based on values of room temperature. The power losses \dot{Q}ₒᵤₜ of the building 2 can also be determined based on outside temperature and based on values of room temperature. The power losses \dot{Q}ₒᵤₜ of the building 2 can still be calculated based on outside temperature and based on values of room temperature.

In some embodiments, the power losses \dot{Q}ₒᵤₜ of the site 2 are estimated based on outside temperature and based on setpoints of temperature. The power losses \dot{Q}ₒᵤₜ of the site 2 can also be determined based on outside temperature and based on setpoints of temperature. The power losses \dot{Q}ₒᵤₜ of the site 2 can still be calculated based on outside temperature and based on setpoints of temperature.

More specifically, the power losses \dot{Q}ₒᵤₜ of the building 2 are estimated based on outside temperature and based on setpoints of temperature. The power losses \dot{Q}ₒᵤₜ of the building 2 can also be determined based on outside temperature and based on setpoints of temperature. The power losses \dot{Q}ₒᵤₜ of the building 2 can still be calculated based on outside temperature and based on setpoints of temperature.

In some embodiments, the power losses \dot{Q}ₒᵤₜ of the site 2 are estimated based on values of room temperature and based on setpoints of temperature. The power losses \dot{Q}ₒᵤₜ of the site 2 can also be determined based on values of room temperature and based on setpoints of temperature. The power losses \dot{Q}ₒᵤₜ of the site 2 can still be calculated based on values of room temperature and based on setpoints of temperature.

More specifically, the power losses \dot{Q}ₒᵤₜ of the building 2 are estimated based on values of room temperature and based on setpoints of temperature. The power losses \dot{Q}ₒᵤₜ of the building 2 can also be determined based on values of room temperature and based on setpoints of temperature. The power losses \dot{Q}ₒᵤₜ of the building 2 can still be calculated based on values of room temperature and based on setpoints of temperature.

In some embodiments, the power losses \dot{Q}ₒᵤₜ of the site 2 are estimated based on outside temperature and on values of room temperature. Setpoints of temperature are also factored into the estimates of power losses \dot{Q}ₒᵤₜ of the site 2. The power losses \dot{Q}ₒᵤₜ of the site 2 can be determined based on outside temperature and on values of room temperature. Setpoints of temperature are also factored into the determinations of power losses \dot{Q}ₒᵤₜ of the site 2. The power losses \dot{Q}ₒᵤₜ of the site 2 can still be calculated based on outside temperature and on values of room temperature and on setpoints of temperature. Setpoints of temperature are also factored into the calculations of power losses \dot{Q}ₒᵤₜ of the site 2.

More specifically, the power losses \dot{Q}ₒᵤₜ of the building 2 are estimated based on outside temperature and on values of room temperature. Setpoints of temperature are also factored into the estimates of power losses \dot{Q}ₒᵤₜ of the building 2. The power losses \dot{Q}ₒᵤₜ of the building 2 can also be determined based on outside temperature and on values of room temperature. Setpoints of temperature are also factored into the determinations of power losses \dot{Q}ₒᵤₜ of the building 2. The power losses \dot{Q}ₒᵤₜ of the building 2 can still be calculated based on outside temperature and on values of room temperature. Setpoints of temperature are also factored into the calculations of power losses \dot{Q}ₒᵤₜ of the building 2.

Changes in power \dot{Q}ₛᵢₜₑ of a site 2 versus time are a function of power intake \dot{Q}ᵢₙ and a function of power losses \dot{Q}ₒᵤₜ:

\dot{Q}ₛᵢₜₑ=\dot{Q}ᵢₙ−\dot{Q}ₒᵤₜ

These changes in power \dot{Q}ₛᵢₜₑ relate to changes in temperature \dot{T}ₛᵢₜₑ at the site 2 via a value of specific heat cₕ:

\dot{Q}ₛᵢₜₑ=cₕ\dot{T}ₛᵢₜₑ

It follows that

\dot{Q}ₛᵢₜₑ=\dot{Q}ᵢₙ−\dot{Q}ₒᵤₜ=cₕ\dot{T}ₛᵢₜₑ

and

\dot{Q}ᵢₙ=cₕ\dot{T}ₛᵢₜₑ+\dot{Q}ₒᵤₜ

Where power losses are a function of the temperature Tₛᵢₜₑ at the site 2 and of outside temperature Tₒᵤₜ the above relationship can be rewritten:

\dot{Q}ᵢₙ=cₕ\dot{T}ₛᵢₜₑ+\dot{Q}ₒᵤₜ(Tₛᵢₜₑ,Tₒᵤₜ)=f(\dot{T}ₛᵢₜₑ,Tₛᵢₜₑ,Tₒᵤₜ)

If power losses \dot{Q}ₒᵤₜ are governed by convective heat transfer, a linear relationship will apply:

\dot{Q}ₒᵤₜ=l·(Tₛᵢₜₑ−Tₒᵤₜ)

The power intake \dot{Q}_{in,est} of the site 2 can then be estimated as

\dot{Q}_{in,est}=cₕ\dot{T}ₛᵢₜₑ+l·(Tₛᵢₜₑ−Tₒᵤₜ)

The power intake \dot{Q}_{in,est} of the site 2 as estimated according to the above relationship depends strongly on short-term changes of the temperature Tₛᵢₜₑ. Those changes can, by way of non-limiting examples, be caused by windows opened, solar radiation, blind positions, etc.

In some embodiments, the temperature Tₛᵢₜₑ at the site 2 is a mean temperature Tₛᵢₜₑ at the site 2. The mean temperature Tₛᵢₜₑ may be an arithmetic mean of temperatures at the site 2. The mean temperature Tₛᵢₜₑ can also be a geometric mean of temperatures at the site 2. In some embodiments, the temperature Tₛᵢₜₑ at the site 2 is produced from a signal of a sensor arranged at the site 2. In some embodiments, the changes in temperature \dot{T}ₛᵢₜₑ at the site 2 are mean changes in temperature \dot{T}ₛᵢₜₑ at the site 2. The mean changes in temperature \dot{T}ₛᵢₜₑ may be arithmetic means of changes in temperature at the site 2. The mean changes in temperature \dot{T}ₛᵢₜₑ can also be geometric means of changes in temperature at the site 2.

A sensor outside the site 2 can record a signal indicative of an outside temperature Tₒᵤₜ. An outside temperature Tₒᵤₜ can then be produced from such a signal. Where a sensor outside the site 2 is unavailable, an outside temperature Tₒᵤₜ can be received from a nearby weather station. An outside temperature Tₒᵤₜ may be received from a service provider via a computer network. For example, the system controller 3 can receive an outside temperature Tₒᵤₜ from a service provider via a computer network. A thermostat can, by way of non-limiting example, receive an outside temperature Tₒᵤₜ from a service provider via a computer network. Also, a valve controller of a valve of the one or more terminal units 4-8 can receive an outside temperature Tₒᵤₜ The outside temperature Tₒᵤₜ can be received from a service provider via a computer network such as the internet.

More specifically, changes in power \dot{Q}_{building} of a building 2 versus time are a function of power intake \dot{Q}ᵢₙ and a function of power losses \dot{Q}ₒᵤₜ:

\dot{Q}_{building}=\dot{Q}ᵢₙ−\dot{Q}ₒᵤₜ

These changes in power \dot{Q}_{building} relate to changes in temperature \dot{T}_{building} at the building 2 via a value of specific heat cₕ:

\dot{Q}_{building}=cₕ\dot{T}_{building}

It follows that

\dot{Q}_{building}=\dot{Q}ᵢₙ−\dot{Q}ₒᵤₜ=cₕ\dot{T}_{building}

and

\dot{Q}ᵢₙ=cₕ\dot{T}_{building}+\dot{Q}ₒᵤₜ

Where power losses are a function of the temperature T_{building} at the building 2 and of outside temperature Tₒᵤₜ, the above relationship can be rewritten:

\dot{Q}ᵢₙ=cₕ\dot{T}_{building}+\dot{Q}ₒᵤₜ(T_{building},Tₒᵤₜ)=f(\dot{T}_{building},T_{building},Tₒᵤₜ)

If power losses \dot{Q}ₒᵤₜ are governed by convective heat transfer, a linear relationship will apply:

\dot{Q}ₒᵤₜ=l·(T_{building}−Tₒᵤₜ)

The power intake \dot{Q}_{in,est} of the building 2 as estimated according to the above relationship depends strongly on short-term changes of the temperature T_{building}. Those changes can, by way of non-limiting examples, be caused by windows opened, solar radiation, blind positions, etc.

The power intake \dot{Q}_{in,est} of the building 2 can then be estimated as

\dot{Q}_{in,est}=cₕ\dot{T}_{building}+l·(T_{building}−Tₒᵤₜ)

In some embodiments, the temperature T_{building} in the building 2 is a mean temperature T_{building} in the building 2. The mean temperature T_{building} may be an arithmetic mean of temperatures within the building 2. The mean temperature T_{building} can also be a geometric mean of temperatures within the building 2. In some embodiments, the temperature T_{building} in the building 2 is produced from a signal of a sensor arranged in the building 2. In some embodiments, the changes in temperature \dot{T}_{building} at the building 2 are mean changes in temperature within the building 2. The mean changes in temperature \dot{T}_{building} may be arithmetic means of changes in temperature within the building 2. The mean changes in temperature \dot{T}_{building} can also be geometric means of changes in temperature within the building 2.

A sensor outside the building 2 can record a signal indicative of an outside temperature Tₒᵤₜ. An outside temperature Tₒᵤₜ can then be produced from such a signal. Where a sensor outside the building 2 is unavailable, an outside temperature Tₒᵤₜ can be received from a nearby weather station. An outside temperature Tₒᵤₜ may be received from a service provider via a computer network. For example, the system controller 3 can receive an outside temperature Tₒᵤₜ from a service provider via a computer network. A thermostat can, by way of non-limiting example, receive an outside temperature Tₒᵤₜ from a service provider via a computer network. Also, a valve controller of a valve of the one or more terminal units 4-8 can receive an outside temperature Tₒᵤₜ The outside temperature Tₒᵤₜ can be received from a service provider via a computer network such as the internet.

Also, changes in power \dot{Q}_{zone} of a zone versus time are a function of power intake \dot{Q}ᵢₙ and a function of power losses \dot{Q}ₒᵤₜ:

\dot{Q}_{zone}=\dot{Q}ᵢₙ−\dot{Q}ₒᵤₜ

These changes in power \dot{Q}_{zone} relate to changes in temperature \dot{T}_{zone} within the zone via a value of specific heat cₕ:

\dot{Q}_{zone}=cₕ\dot{T}_{zone}

It follows that

\dot{Q}_{zone}=\dot{Q}ᵢₙ−\dot{Q}ₒᵤₜ=cₕ\dot{T}_{zone}

and

\dot{Q}ᵢₙ=cₕ\dot{T}_{zone}+\dot{Q}ₒᵤₜ

Where power losses are a function of the temperature T_{zone} in the zone and of outside temperature Tₒᵤₜ, the above relationship can be rewritten:

\dot{Q}ᵢₙ=cₕ\dot{T}_{zone}+\dot{Q}ₒᵤₜ(T_{zone},Tₒᵤₜ)=f(\dot{T}_{zone},T_{zone},Tₒᵤₜ)

If power losses \dot{Q}ₒᵤₜ are governed by convective heat transfer, a linear relationship will apply:

\dot{Q}ₒᵤₜ=l·(T_{zone}−Tₒᵤₜ)

The power intake \dot{Q}_{in,est} of the zone can then be estimated as

\dot{Q}_{in,est}=cₕ\dot{T}_{zone}+l·(T_{zone}−Tₒᵤₜ)

The power intake \dot{Q}_{in,est} of the zone as estimated according to the above relationship depends strongly on short-term changes of the temperature T_{zone}. Those changes can, by way of non-limiting examples, be caused by windows opened, solar radiation, blind positions, etc.

In some embodiments, the temperature T_{zone} in the zone is a mean temperature T_{zone} in the zone. The mean temperature T_{zone} may be an arithmetic mean of temperatures within the zone. The mean temperature T_{zone} can also be a geometric mean of temperatures within the zone. In some embodiments, the temperature T_{zone} in the zone is produced from a signal of a sensor arranged in the zone. In some embodiments, the changes in temperature \dot{T}_{zone} in the zone are mean changes in temperature in the zone. The mean changes in temperature \dot{T}_{zone} may be arithmetic means of changes in temperature within the zone. The mean changes in temperature \dot{T}_{zone} can also be geometric means of changes in temperature within the zone.

A sensor outside the site 2 and outside the zone can record a signal indicative of an outside temperature Tₒᵤₜ. An outside temperature Tₒᵤₜ can then be produced from such a signal. Where a sensor outside the site 2 and outside the zone is unavailable, an outside temperature Tₒᵤₜ can be received from a nearby weather station. An outside temperature Tₒᵤₜ may be received from a service provider via a computer network. For example, the system controller 3 can receive an outside temperature Tₒᵤₜ from a service provider via a computer network. A thermostat can, by way of non-limiting example, receive an outside temperature Tₒᵤₜ from a service provider via a computer network. Also, a valve controller of a valve of the one or more terminal units 4-8 can receive an outside temperature Tₒᵤₜ. The outside temperature Tₒᵤₜ can be received from a service provider via a computer network such as the internet.

Still more specifically, changes in power \dot{Q}_{space} of a space versus time are a function of power intake \dot{Q}ᵢₙ and a function of power losses \dot{Q}ₒᵤₜ:

\dot{Q}_{space}=\dot{Q}ᵢₙ−\dot{Q}ₒᵤₜ

These changes in power \dot{Q}_{space} relate to changes in temperature \dot{T}_{space} within the space via a value of specific heat cₕ:

\dot{Q}_{space}=cₕ\dot{T}_{space}

It follows that

\dot{Q}_{space}=\dot{Q}ᵢₙ−\dot{Q}ₒᵤₜ=cₕ\dot{T}_{space}

and

\dot{Q}ᵢₙ=cₕ\dot{T}_{space}+\dot{Q}ₒᵤₜ

Where power losses are a function of the temperature T_{space} in the space and of outside temperature Tₒᵤₜ, the above relationship can be rewritten:

\dot{Q}ᵢₙ=cₕ\dot{T}_{space}+\dot{Q}ₒᵤₜ(T_{space},Tₒᵤₜ)=f(\dot{T}_{space},T_{space},Tₒᵤₜ)

If power losses \dot{Q}ₒᵤₜ are governed by convective heat transfer, a linear relationship will apply:

\dot{Q}ₒᵤₜ=l·(T_{space}−Tₒᵤₜ)

The power intake \dot{Q}_{in,est} of the space can then be estimated as

\dot{Q}_{in,est}=cₕ\dot{T}_{space}+l·(T_{space}−Tₒᵤₜ)

The power intake \dot{Q}_{in,est} of the space as estimated according to the above relationship depends strongly on short-term changes of the temperature T_{space}. Those changes can, by way of non-limiting examples, be caused by windows opened, solar radiation, blind positions, etc.

In some embodiments, the temperature T_{space} in the space is a mean temperature T_{space} in the space. The mean temperature T_{space} may be an arithmetic mean of temperatures within the space. The mean temperature T_{space} can also be a geometric mean of temperatures within the space. In some embodiments, the temperature T_{space} in the space is produced from a signal of a sensor arranged in the space.

In some embodiments, the changes in temperature \dot{T}_{space} in the space are mean changes in temperature in the space. The mean changes in temperature \dot{T}_{space} may be arithmetic means of changes in temperature within the space. The mean changes in temperature \dot{T}_{space} can also be geometric means of changes in temperature within the space.

A sensor outside the site 2 and outside the space can record a signal indicative of an outside temperature Tₒᵤₜ. An outside temperature Tₒᵤₜ can then be produced from such a signal. Where a sensor outside the site 2 and outside the space is unavailable, an outside temperature Tₒᵤₜ can be received from a nearby weather station. An outside temperature Tₒᵤₜ may be received from a service provider via a computer network. For example, the system controller 3 can receive an outside temperature Tₒᵤₜ from a service provider via a computer network. A thermostat can, by way of non-limiting example, receive an outside temperature Tₒᵤₜ from a service provider via a computer network. Also, a valve controller of a valve of the one or more terminal units 4-8 can receive an outside temperature Tₒᵤₜ. The outside temperature Tₒᵤₜ can be received from a service provider via a computer network such as the internet.

Yet more specifically, changes in power \dot{Q}ᵣₒₒₘ of a room versus time are a function of power intake \dot{Q}ᵢₙ and a function of power losses \dot{Q}ₒᵤₜ:

\dot{Q}ᵣₒₒₘ=\dot{Q}ᵢₙ−\dot{Q}ₒᵤₜ

These changes in power \dot{Q}ᵣₒₒₘ relate to changes in temperature \dot{T}ᵣₒₒₘ within the room via a value of specific heat cₕ:

\dot{Q}ᵣₒₒₘ=cₕ\dot{T}ᵣₒₒₘ

It follows that

\dot{Q}ᵣₒₒₘ=\dot{Q}ᵢₙ−\dot{Q}ₒᵤₜ=cₕ\dot{T}ᵣₒₒₘ

and

\dot{Q}ᵢₙ=cₕ\dot{T}ᵣₒₒₘ+\dot{Q}ₒᵤₜ

Where power losses are a function of the temperature Tᵣₒₒₘ in the room and of outside temperature Tₒᵤₜ the above relationship can be rewritten:

\dot{Q}ᵢₙ=cₕ\dot{T}ᵣₒₒₘ+\dot{Q}ₒᵤₜ(Tᵣₒₒₘ,Tₒᵤₜ)=f(\dot{T}ᵣₒₒₘ,Tᵣₒₒₘ,Tₒᵤₜ)

If power losses \dot{Q}ₒᵤₜ are governed by convective heat transfer, a linear relationship will apply:

\dot{Q}ₒᵤₜ=l·(Tᵣₒₒₘ−Tₒᵤₜ)

The power intake \dot{Q}_{in,est} of the room can then be estimated as

\dot{Q}_{in,est}=cₕ\dot{T}ᵣₒₒₘ+l·(Tᵣₒₒₘ−Tₒᵤₜ)

The power intake \dot{Q}_{in,est} of the room as estimated according to the above relationship depends strongly on short-term changes of the temperature Tᵣₒₒₘ. Those changes can, by way of non-limiting examples, be caused by windows opened, solar radiation, blinds positions, etc.

In some embodiments, the temperature Tᵣₒₒₘ in the room is a mean temperature Tᵣₒₒₘ in the room. The mean temperature Tᵣₒₒₘ may be an arithmetic mean of temperatures within the room. The mean temperature Tᵣₒₒₘ can also be a geometric mean of temperatures within the room. In some embodiments, the temperature Tᵣₒₒₘ in the room is produced from a signal of a sensor arranged in the room. In some embodiments, the changes in temperature \dot{T}ᵣₒₒₘ in the room are mean changes in temperature in the room. The mean changes in temperature \dot{T}ᵣₒₒₘ may be arithmetic means of changes in temperature within the room. The mean changes in temperature \dot{T}ᵣₒₒₘ can also be geometric means of changes in temperature within the room.

A sensor outside the site 2 and outside the room can record a signal indicative of an outside temperature Tₒᵤₜ. An outside temperature Tₒᵤₜ can then be produced from such a signal. Where a sensor outside the site 2 and outside the room is unavailable, an outside temperature Tₒᵤₜ can be received from a nearby weather station. An outside temperature Tₒᵤₜ may be received from a service provider via a computer network. For example, the system controller 3 can receive an outside temperature Tₒᵤₜ from a service provider via a computer network. A thermostat can, by way of non-limiting example, receive an outside temperature Tₒᵤₜ from a service provider via a computer network. Also, a valve controller of a valve of the one or more terminal units 4-8 can receive an outside temperature Tₒᵤₜ. The outside temperature Tₒᵤₜ can be received from a service provider via a computer network such as the internet.

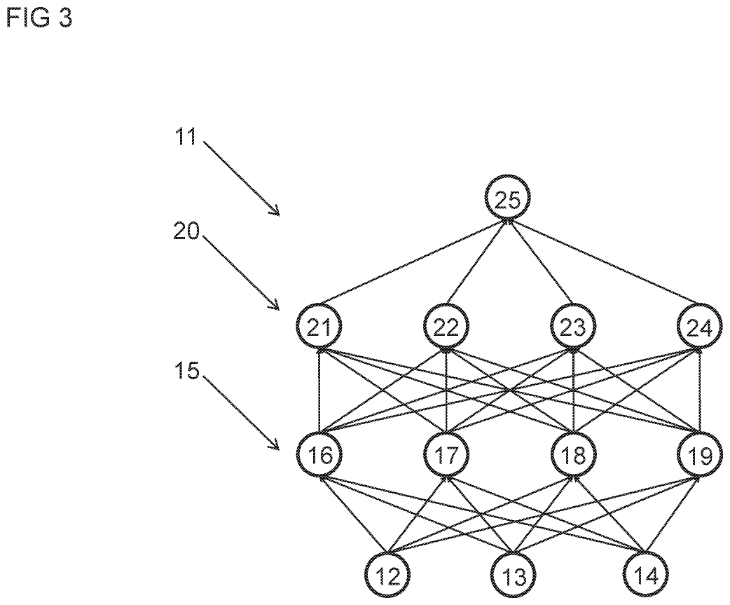

To mitigate adverse influence of short-term fluctuations of temperature, an approach involving artificial intelligence is chosen. FIG. 3 shows a calibrated model in the form of a neural network 11. The neural network 11 of FIG. 3 is employed to estimate cooling power and/or heating power \dot{Q}_{in,est}. Advantageously, the neural network 11 of FIG. 3 is employed to determine cooling power and/or heating power \dot{Q}_{in,est}. Ideally, the neural network 11 of FIG. 3 is employed to calculate cooling power and/or heating power \dot{Q}_{in,est}.

The neural network 11 comprises input neurons 12-14. In some embodiments, a first input neuron 12 corresponds to or is associated with a setpoint temperature. The setpoint temperature can, by way of non-limiting example, be a setpoint temperature of a site 2 and/or of a building 2. The setpoint temperature can, by way of another non-limiting example, also be a setpoint temperature of a zone and/or of a space and/or of a room. In some embodiments, a second input neuron 13 corresponds to or is associated with a temperature Tₛᵢₜₑ at the site 2. In some embodiments, the second input neuron 13 corresponds to or is associated with a temperature T_{building} within the building 2. In some embodiments, the second input neuron 13 corresponds to or is associated with a temperature T_{zone} within a zone. In some embodiments, the second input neuron 13 corresponds to or is associated with a temperature T_{space} within a space. In some embodiments, the second input neuron 13 corresponds to or is associated with a temperature Tᵣₒₒₘ within a room. In some embodiments, a third input neuron 14 corresponds to or is associated with a control signal indicative of a valve position. More specifically, a third input neuron 14 can correspond to or be associated with a control signal indicative of a valve stroke. In some embodiments, a third input neuron 14 corresponds to or is associated with a valve position. More specifically, the third input neuron 14 can correspond to or be associated with a valve stroke.

In some embodiments, the input to the neural network 11 is normalised. The neural network 11 also comprises an output neuron 25. The output neuron 25 corresponds to or is associated with an estimated intake of power \dot{Q}_{in,est}. The estimated intake of power \dot{Q}_{in,est} corresponds to an estimated cooling power and/or an estimated heating power. In some embodiments, the estimated intake of power \dot{Q}_{in,est} is an estimated cooling power and/or an estimated heating power.

The neural network 11 also comprises one or more hidden layers 15, 20, each layer 15, 20 having one or more hidden neurons 16-19, 21-24. In some embodiments, the neural network 11 comprises two layers 15, 20 of hidden neurons. The neurons 16-19, 21-24 can, by way of non-limiting example, have activation functions such as sigmoid

$$s i g ( x ) = \frac{1}{1 + {e}^{x}}$$

and/or hyperbolic tangent and/or step-wise activation and/or rectified linear unit functions. The neurons 16-19, 21-24 are advantageously biased. The neural network 11 may be trained under test conditions. A series of measurements obtained under various test conditions is employed to train the neural network 11.

The neural network 11 can, by way of non-limiting example, be trained by a supervised training algorithm such as backpropagation. In some embodiments, the neural network 11 is or has been trained using an evolutionary algorithm such as a genetic algorithm. The skilled artisan can combine training algorithms. A genetic algorithm can, by way of example, be employed to find a coarse estimate of the weights of the connections of neural network 11. A backpropagation algorithm is then employed to further improve on the performance of the network 11.

After training the configuration of neural network 11 and/or the weights of the connections of neural network 11 are saved in a memory. The memory may be a non-volatile memory. The configuration of the neural network 11 and/or the weights of the connections of the neural network 11 define a procedure of estimating power intake \dot{Q}_{in,est}. The procedure of estimating power intake \dot{Q}_{in,est} may be a procedure of estimating cooling power and/or heating power. The procedure may be applied to a site 2. The procedure can also be applied to a building 2. The procedure may be applied to a zone within a site 2 or within a building 2. The procedure may be applied to a space such as a space within a site 2 or within a building 2. The procedure can also be applied to a room such as a room within a site 2 or within a building 2.

In some embodiments, the neural network comprises an input layer as outlined above. A first dense layer connects to the input layer. The first dense layer has 182 biased neurons. Each of these neurons has a rectified linear unit (relu) activation function:

relu(x)=max(0,x)

The first dense layer provides a plurality of connections to the previous layer. The number of connections to the previous layer is commensurate with the neurons of the input layer and with the neurons of the first dense layer. A second dense layer connects to the first dense layer. The second dense layer has 182 biased neurons. Each of these neurons has a rectified linear unit (relu) activation function:

relu(x)=max(0,x)

The second dense layer provides a plurality of connections to the previous layer. The number of connections to the previous layer is commensurate with the neurons of the first dense layer and with the neurons of the second dense layer. A third dense layer connects to the second dense layer. The third dense layer has 182 biased neurons. Each of these neurons has a rectified linear unit (relu) activation function:

relu(x)=max(0,x)

The third dense layer provides a plurality of connections to the previous layer. The number of connections to the previous layer is commensurate with the neurons of the second dense layer and with the neurons of the third dense layer. A fourth dense layer connects to the third dense layer. The fourth dense layer has 182 biased neurons. Each of these neurons has a rectified linear unit (relu) activation function:

relu(x)=max(0,x)

The fourth dense layer provides a plurality of connections to the previous layer. The number of connections to the previous layer is commensurate with the neurons of the third dense layer and with the neurons of the fourth dense layer. A fifth dense layer connects to the fourth dense layer. The fifth dense layer has a single biased output neuron. The output neuron has a linear activation function:

linear(x)=x

The fifth dense layer provides a plurality of connections to the previous layer. The number of connections to the previous layer is commensurate with the number of neurons of the fourth dense layer. The number of connections to the previous layer is also commensurate with the single neuron of the fifth dense layer.

Activation functions in the form of rectified linear unit functions mitigate issues due to vanishing gradients. Consequently, the calibrated network and/or the neural network 11 may employ single precision floating point numbers rather than double precision floating point numbers as weights. The calibrated network and/or the neural network 11 will require less memory.

The neural network 11 is or has been trained using backpropagation. To that end, a data set is split into a training data set and a test data set. The sets contain data indicative of values provided to the input neurons of the network and indicative of the output neuron of the network. The below table provides examples of such data:

| | site temperature | | |
|---|---|---|---|
| | Tₛᵢₜₑ/ | | |
| | building temperature | | |
| | T_{building}/ | | |
| | zone temperature | | |
| | T_{zone}/ | | |
| | space temperature | | |
| | T_{space}/ | | |
| setpoint | room temperature | valve | intake Of |
| temperature | Tᵣₒₒₘ | position | power \dot{Q}ᵢₙ |
| 292.15 Kelvin | 292.02 Kelvin | 28.5 % | 26.0 W |
| 292.15 Kelvin | 291.99 Kelvin | 37.1 % | 119 W |
| 292.15 Kelvin | 291.98 Kelvin | 43.4 % | 313 W |
| 292.15 Kelvin | 291.97 Kelvin | 48.4 % | 460 W |
| 292.15 Kelvin | 291.97 Kelvin | 52.6 % | 568 W |

The trained neural network 11 can be employed to control a system for heating and/or ventilation and/or air-conditioning 1 at the site 2. The trained neural network 11 can also be employed to control a system for heating and/or ventilation 1 and/or air-conditioning at the building 2. The trained neural network 11 can still be employed to control a system for heating and/or ventilation and/or air-conditioning 1 within a zone. The zone can be a zone of a site or of a building 2. The trained neural network 11 can also be employed to control a system for heating and/or ventilation and/or air-conditioning 1 within a space. The space can be a space of a site or of a building 2. The trained neural network 11 can still be employed to control a system for heating and/or ventilation and/or air-conditioning 1 within a room. The room can be a room of a site or of a building 2.

The trained neural network 11 can also be employed by a thermostat such as a smart thermostat. The thermostat can comprise a display and a processor. The processor of the thermostat estimates power intake \dot{Q}_{in,est} via the neural network 11. In some embodiments, the processor estimates cooling power and/or heating power \dot{Q}_{in,est} via the neural network 11. The processor produces a graphics signal from the estimate and sends the estimate to the display. The display of the thermostat shows the estimate of power intake \dot{Q}_{in,est} to a user and/or to an operator. The display of the thermostat advantageously shows the estimate of cooling power and/or heating power \dot{Q}_{in,est} to a user and/or to an operator. In some embodiments, the display of the thermostat shows the estimate to a user and/or to an operator via a graphical user interface.

The trained neural network 11 can also be employed by a system controller 3. The system controller 3 can comprise a display and a processor. The processor of the system controller 3 estimates power intake \dot{Q}_{in,est} via the neural network 11. In some embodiments, the processor estimates cooling power and/or heating power \dot{Q}_{in,est} via the neural network 11. The processor produces a graphics signal from the estimate and sends the estimate to the display. The display of the system controller 3 shows the estimate of power intake \dot{Q}_{in,est} to a user and/or to an operator. The display of the system controller 3 may show the estimate of cooling power and/or heating power \dot{Q}_{in,est} to a user and/or to an operator. In some embodiments, the display of the system controller 3 shows the estimate to a user and/or to an operator via a graphical user interface.

A grid operator can rely on one or more estimates produced by the neural network 11. The grid operator can, by way of non-limiting example, receive one or more estimates of power intake \dot{Q}_{in,est} at the site 2. More specifically, the grid operator can receive one or more estimates of cooling power and/or of heating power at the site 2. The grid operator can then produce one or more demand response signals based on the received one or more estimates. The grid operator sends these one or more demand response signals back to the site 2. Power can then be curtailed at the site 2 in consequence of the one or more demand response signal.

The grid operator can, by way of another non-limiting example, receive one or more estimates of power intake \dot{Q}_{in,est} at a building 2. More specifically, the grid operator can receive one or more estimates of cooling power and/or of heating power at the building 2. The grid operator can then produce one or more demand response signals based on the received one or more estimates. The grid operator sends these one or more demand response signals back to the building 2. Power can then be curtailed at the building 2 in consequence of the one or more demand response signal.

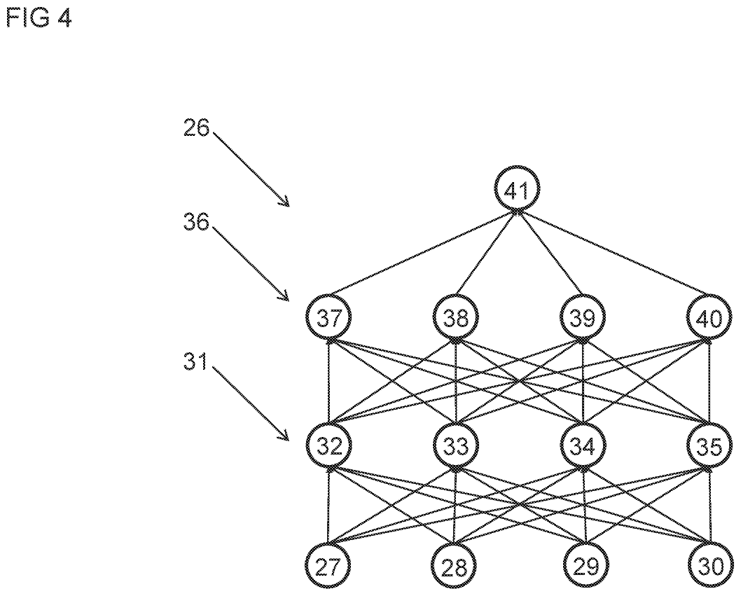

The neural network 26 as shown in FIG. 4 comprises input neurons 27-30. In some embodiments, a first input neuron 27 corresponds to or is associated with a setpoint temperature. The setpoint temperature can, by way of non-limiting example, be a setpoint temperature of a site 2 and/or of a building 2. The setpoint temperature can, by way of another non-limiting example, also be a setpoint temperature of a zone and/or of a space and/or of a room. In some embodiments, a second input neuron 28 corresponds to or is associated with a temperature Tₛᵢₜₑ at the site 2. In some embodiments, the second input neuron 28 corresponds to or is associated with a temperature T_{building} within the building 2. In some embodiments, the second input neuron 28 corresponds to or is associated with a temperature T_{zone} within a zone. In some embodiments, the second input neuron 28 corresponds to or is associated with a temperature T_{space} within a space. In some embodiments, the second input neuron 28 corresponds to or is associated with a temperature Tᵣₒₒₘ within a room. In some embodiments, a third input neuron 29 corresponds to or is associated with a control signal indicative of a valve position. More specifically, a third input neuron 29 can correspond to or be associated with a control signal indicative of a valve stroke. Ideally, a third input neuron 29 corresponds to or is associated with a valve position. More specifically, the third input neuron 29 can correspond to or be associated with a valve stroke. A fourth input neuron 30 corresponds to or is associated with outside temperature Tₒᵤₜ.

In some embodiments, any input to the neural network 26 is normalised. The neural network 26 also comprises an output neuron 41. The output neuron 41 corresponds to or is associated with an estimated intake of power \dot{Q}_{in,est}. The estimated intake of power \dot{Q}_{in,est} may correspond to an estimated cooling power and/or an estimated heating power. The estimated intake of power \dot{Q}_{in,est} may be an estimated cooling power and/or an estimated heating power.

The neural network 26 also comprises one or more hidden layers 31, 36, each layer 31, 36 having one or more hidden neurons 32-35, 37-40. In some embodiments, the neural network 26 comprises two layers 31, 36 of hidden neurons. The neurons 32-35, 37-40 can, by way of non-limiting example, have activation functions such as sigmoid

$$s i g ( x ) = \frac{1}{1 + {e}^{x}}$$

and/or hyperbolic tangent and/or step-wise activation and/or rectified linear unit functions. The neurons 32-35, 37-40 are advantageously biased. The neural network 26 may be trained under test conditions. A series of measurements obtained under various test conditions is employed to train the neural network 26.

The neural network 26 can, by way of non-limiting example, be trained by a supervised training algorithm such as backpropagation. In some embodiments, the neural network 26 is or has been trained using an evolutionary algorithm such as a genetic algorithm. The skilled artisan can combine training algorithms. A genetic algorithm can, by way of example, be employed to find a coarse estimate of the weights of the connections of neural network 26. A backpropagation algorithm is then employed to further improve on the performance of the network 26.

After training the configuration of neural network 26 and/or the weights of the connections of neural network 26 are saved in a memory. The memory may be a non-volatile memory. The configuration of the neural network 26 and/or the weights of the connections of the neural network 26 define a procedure of estimating power intake \dot{Q}_{in,est}. The procedure of estimating power intake \dot{Q}_{in,est} may be a procedure of estimating cooling power and/or heating power. The procedure may be applied to a site 2. The procedure can also be applied to a building 2. The procedure may be applied to a zone within a site 2 or within a building 2. The procedure is ideally applied to a space such as a space within a site 2 or within a building 2. The procedure can also be applied to a room such as a room within a site 2 or within a building 2.

In some embodiments, the neural network comprises an input layer as outlined above. A first dense layer connects to the input layer. The first dense layer has 182 biased neurons. Each of these neurons has a rectified linear unit (relu) activation function:

relu(x)=max(0,x)

The first dense layer provides a plurality of connections to the previous layer. The number of connections to the previous layer is commensurate with the neurons of the input layer and with the neurons of the first dense layer. A second dense layer connects to the first dense layer. The second dense layer has 182 biased neurons. Each of these neurons has a rectified linear unit (relu) activation function:

relu(x)=max(0,x)

The second dense layer provides a plurality of connections to the previous layer. The number of connections to the previous layer is commensurate with the neurons of the first dense layer and with the neurons of the second dense layer. A third dense layer connects to the second dense layer. The third dense layer has 182 biased neurons. Each of these neurons has a rectified linear unit (relu) activation function:

relu(x)=max(0,x)

The third dense layer provides a plurality of connections to the previous layer. The number of connections to the previous layer is commensurate with the neurons of the second dense layer and with the neurons of the third dense layer. A fourth dense layer connects to the third dense layer. The fourth dense layer has 182 biased neurons. Each of these neurons has a rectified linear unit (relu) activation function:

relu(x)=max(0,x)

The fourth dense layer provides a plurality of connections to the previous layer. The number of connections to the previous layer is commensurate with the neurons of the third dense layer and with the neurons of the fourth dense layer. A fifth dense layer connects to the fourth dense layer. The fifth dense layer has a single biased output neuron. The output neuron has a linear activation function:

linear(x)=x

The fifth dense layer provides a plurality of connections to the previous layer. The number of connections to the previous layer is commensurate with the number of neurons of the fourth dense layer. The number of connections to the previous layer is also commensurate with the single neuron of the fifth dense layer.

Activation functions in the form of rectified linear unit functions mitigate issues due to vanishing gradients. Consequently, the calibrated network and/or the neural network 26 may employ single precision floating point numbers rather than double precision floating point numbers as weights. The calibrated network and/or the neural network 26 will require less memory.

The neural network 26 is or has been trained using backpropagation. To that end, a data set is split into a training data set and a test data set. The sets contain data indicative of values provided to the input neurons of the network and indicative of the output neuron of the network. The below table provides examples of such data:

| | site | | | |
|---|---|---|---|---|
| | temperature | | | |
| | Tₛᵢₜₑ/ | | | |
| | building | | | |
| | temperature | | | |
| | T_{building}/ | | | |
| | zone | | | |
| | temperature | | | |
| | T_{zone}/ | | | |
| | space | | | |
| | temperature | | | |
| | T_{space}/ | | | intake |
| | room | | outside | of |
| setpoint | temperature | valve | temperature | power |
| temperature | Tᵣₒₒₘ | position | Tₒᵤₜ | Qᵢₙ |
| 292.15 Kelvin | 292.02 Kelvin | 28.5 % | 279.45 Kelvin | 26.0 W |
| 292.15 Kelvin | 291.99 Kelvin | 37.1 % | 277.51 Kelvin | 119 W |
| 292.15 Kelvin | 291.98 Kelvin | 43.4 % | 278.69 Kelvin | 313 W |
| 292.15 Kelvin | 291.97 Kelvin | 48.4 % | 276.33 Kelvin | 460 W |
| 292.15 Kelvin | 291.97 Kelvin | 52.6 % | 271.85 Kelvin | 568 W |

The trained neural network 26 can be employed to control a system for heating and/or ventilation and/or air-conditioning 1 at the site 2. The trained neural network 26 can also be employed to control a system for heating and/or ventilation 1 and/or air-conditioning at the building 2. The trained neural network 26 can still be employed to control a system for heating and/or ventilation and/or air-conditioning 1 within a zone. The zone can be a zone of a site or of a building 2. The trained neural network 26 can also be employed to control a system for heating and/or ventilation and/or air-conditioning 1 within a space. The space can be a space of a site or of a building 2. The trained neural network 26 can still be employed to control a system for heating and/or ventilation and/or air-conditioning 1 within a room. The room can be a room of a site or of a building 2.

The trained neural network 26 can also be employed by a thermostat such as a smart thermostat. The thermostat can comprise a display and a processor. The processor of the thermostat estimates power intake \dot{Q}_{in,est} via the neural network 26. In some embodiments, the processor estimates cooling power and/or heating power \dot{Q}_{in,est} via the neural network 26. The processor produces a graphics signal from the estimate and sends the estimate to the display. The display of the thermostat shows the estimate of power intake \dot{Q}_{in,est} to a user and/or to an operator. The display of the thermostat shows the estimate of cooling power and/or heating power \dot{Q}_{in,est} to a user and/or to an operator. In some embodiments, the display of the thermostat shows the estimate to a user and/or to an operator via a graphical user interface.

The trained neural network 26 can also be employed by a system controller 3. The system controller 3 can comprise a display and a processor. The processor of the system controller 3 estimates power intake \dot{Q}_{in,est} via the neural network 26. Preferably, the processor estimates cooling power and/or heating power \dot{Q}_{in,est} via the neural network 26. The processor produces a graphics signal from the estimate and sends the estimate to the display. The display of the system controller 3 shows the estimate of power intake \dot{Q}_{in,est} to a user and/or to an operator. The display of the system controller 3 shows the estimate of cooling power and/or heating power \dot{Q}_{in,est} to a user and/or to an operator. In some embodiments, the display of the system controller 3 shows the estimate to a user and/or to an operator via a graphical user interface.

A grid operator can rely on one or more estimates produced by the neural network 26. The grid operator can, by way of non-limiting example, receive one or more estimates of power intake \dot{Q}_{in,est} at the site 2. In some embodiments, the grid operator can receive one or more estimates of cooling power and/or of heating power at the site 2. The grid operator can then produce one or more demand response signals based on the received one or more estimates. The grid operator sends these one or more demand response signals back to the site 2. Power can then be curtailed at the site 2 in consequence of the one or more demand response signal.

The grid operator can, by way of another non-limiting example, receive one or more estimates of power intake \dot{Q}_{in,est} at a building 2. In some embodiments, the grid operator can receive one or more estimates of cooling power and/or of heating power at the building 2. The grid operator can then produce one or more demand response signals based on the received one or more estimates. The grid operator sends these one or more demand response signals back to the building 2. Power can then be curtailed at the building 2 in consequence of the one or more demand response signal.

Any steps of a method according to the present disclosure can be embodied in hardware and/or in a software module executed by a processor. Any steps of such a method can also be embodied in a software module executed by a processor inside a container using operating system level virtualisation. Any steps of such a method can still be embodied in a cloud computing arrangement. In some embodiments, any elements of a method incorporating teachings of the present disclosure may be implemented in a combination of the above embodiments. The software may include a firmware and/or a hardware driver run by the operating system and/or an application program. Thus, the disclosure also relates to a computer program product for performing the operations presented herein. If implemented in software, the functions described may be stored as one or more instructions on a computer-readable medium. Storage media that can be used include, by way of non-limiting examples, random access memory (RAM) and/or read only memory (ROM) and/or flash memory. Storage media can, by way of non-limiting examples, also include EPROM memory and/or EEPROM memory and/or registers and/or a hard disk and/or a removable disk. Further storage media can, by way of non-limiting examples, include other optical disks and/or any available media that can be accessed by a computer. Storage media can still, by way of non-limiting example, include any other IT equipment and appliance.

As described in detail herein, the present disclosure describes methods and/or systems for estimating a heat transfer \dot{Q}_{in,est} via one or more thermal energy exchangers (4-8). An example method comprises:
acquiring a signal indicative of a setpoint temperature;
acquiring a signal indicative of an inside temperature at a site (2);
acquiring one or more signals indicative of positions of valves of the one or more thermal energy exchangers (4-8);
producing a value of setpoint temperature from the signal indicative of the setpoint temperature;
producing a value of inside temperature Tₛᵢₜₑ at the site (2) from the signal indicative of inside temperature;
producing a value of position from the one or more signals indicative of positions of the valves;
providing a calibrated model (11; 26) with the value of setpoint temperature and with the value of inside temperature Tₛᵢₜₑ at the site (2) and with the value of position; and
using the calibrated model (11; 26) to estimate the heat transfer \dot{Q}_{in,est} via the one or more thermal energy exchangers (4-8).

In some embodiments, the heat transfer \dot{Q}_{in,est} comprises a cooling power and/or a heating power. In some embodiments, the heat transfer \dot{Q}_{in,est} is a cooling power and/or a heating power.

In some embodiments, the site (2) is a building (2). Consequently, the value of inside temperature Tₛᵢₜₑ at the site (2) is a value of inside temperature T_{building} in the building (2). In some embodiments, the site (2) is a zone of a building (2). Consequently, the value of inside temperature Tₛᵢₜₑ at the site (2) is a value of inside temperature T_{zone} in the zone of the building (2). In some embodiments, the site (2) is a space of a building (2).

Consequently, the value of inside temperature Tₛᵢₜₑ at the site (2) is a value of inside temperature T_{space} in the space of the building (2). In some embodiments, the site (2) is a room of a building (2). Consequently, the value of inside temperature Tₛᵢₜₑ at the site (2) is a value of inside temperature Tᵣₒₒₘ in the room of the building (2).

The method of estimating a heat transfer \dot{Q}_{in,est} via one or more thermal energy exchangers (4-8) is a method of estimating a heat transfer \dot{Q}_{in,est} via one or more thermal energy exchangers (4-8) of a site (2). The method of estimating a heat transfer \dot{Q}_{in,est} via one or more thermal energy exchangers (4-8) preferably is a method of estimating a heat transfer \dot{Q}_{in,est} via one or more thermal energy exchangers (4-8) of a building (2). The method of estimating a heat transfer \dot{Q}_{in,est} via one or more thermal energy exchangers (4-8) may be a method of estimating a heat transfer \dot{Q}_{in,est} via one or more thermal energy exchangers (4-8) of a zone of a building (2). The method of estimating a heat transfer \dot{Q}_{in,est} via one or more thermal energy exchangers (4-8) can also be a method of estimating a heat transfer \dot{Q}_{in,est} via one or more thermal energy exchangers (4-8) of a space of a building (2). The method of estimating a heat transfer \dot{Q}_{in,est} via one or more thermal energy exchangers (4-8) can still be a method of estimating a heat transfer \dot{Q}_{in,est} via one or more thermal energy exchangers (4-8) of a room of a building (2).

The instant disclosure also deals with any of the aforementioned methods of estimating a heat transfer \dot{Q}_{in,est}, the method further comprising acquiring a signal indicative of a setpoint temperature for the site (2).

The present disclosure further deals with any of the aforementioned methods of estimating a heat transfer \dot{Q}_{in,est}, the method further comprising acquiring a signal indicative of a setpoint temperature of the site (2).

The instant disclosure still deals with any of the aforementioned methods of estimating a heat transfer \dot{Q}_{in,est}, the method further comprising acquiring a signal indicative of a setpoint temperature for the building (2).

The present disclosure still further deals with any of the aforementioned methods of estimating a heat transfer \dot{Q}_{in,est}, the method further comprising acquiring a signal indicative of a setpoint temperature of the building (2).

The instant disclosure yet further deals with any of the aforementioned methods of estimating a heat transfer \dot{Q}_{in,est}, the method further comprising acquiring a signal indicative of a setpoint temperature for the zone of the building (2).

The present disclosure also deals with any of the aforementioned methods of estimating a heat transfer \dot{Q}_{in,est}, the method further comprising acquiring a signal indicative of a setpoint temperature of the zone of the building (2).

The instant disclosure still deals with any of the aforementioned methods of estimating a heat transfer \dot{Q}_{in,est}, the method further comprising acquiring a signal indicative of a setpoint temperature for the space of the building (2).

The present disclosure further deals with any of the aforementioned methods of estimating a heat transfer \dot{Q}_{in,est}, the method further comprising acquiring a signal indicative of a setpoint temperature of the space of the building (2).

The instant disclosure still with any of the aforementioned methods of estimating a heat transfer \dot{Q}_{in,est}, the method further comprising acquiring a signal indicative of a setpoint temperature for the room of the building (2).

The present disclosure still further deals with any of the aforementioned methods of estimating a heat transfer \dot{Q}_{in,est}, the method further comprising acquiring a signal indicative of a setpoint temperature of the room of the building (2).

In some embodiments, the calibrated model (11; 26) is or has been trained using a plurality of training data sets, each training data set comprising a value of setpoint temperature and a value of inside temperature Tₛᵢₜₑ at the site (2) and a value of position and a value of heat transfer \dot{Q}ᵢₙ. In some embodiments, the calibrated model (11; 26) is or has been trained using a plurality of training data sets, each training data set comprising a training value of setpoint temperature and a training value of inside temperature Tₛᵢₜₑ at the site (2) and a training value of position and a training value of heat transfer \dot{Q}ᵢₙ. A heat meter can, by way of non-limiting example, be used to estimate and/or to determine the (training) value of heat transfer \dot{Q}ᵢₙ.

In some embodiments, the calibrated model (11; 26) is or has been tested using a plurality of test data sets, each test data set comprising a value of setpoint temperature and a value of inside temperature Tₛᵢₜₑ at the site (2) and a value of position and a value of heat transfer \dot{Q}ᵢₙ. In some embodiments, the calibrated model (11; 26) is or has been tested using a plurality of test data sets, each test data set comprising a test value of setpoint temperature and a test value of inside temperature Tₛᵢₜₑ at the site (2) and a test value of position and a test value of heat transfer \dot{Q}ᵢₙ. A heat meter can, by way of non-limiting example, be used to estimate and/or to determine the (test) value of heat transfer \dot{Q}ᵢₙ.

In some embodiments, the calibrated model (11; 26) comprises a trained model. It is still envisaged that the calibrated model (11; 26) is a trained model.

In some embodiments, the trained model (11; 26) is or has been trained using a plurality of training data sets, each training data set comprising a value of setpoint temperature and a value of inside temperature Tₛᵢₜₑ at the site (2) and a value of position and a value of heat transfer \dot{Q}ᵢₙ. In some embodiments, the trained model (11; 26) is or has been trained using a plurality of training data sets, each training data set comprising a training value of setpoint temperature and a training value of inside temperature Tₛᵢₜₑ at the site (2) and a training value of position and a training value of heat transfer \dot{Q}ᵢₙ. A heat meter can, by way of non-limiting example, be used to estimate and/or to determine the (training) value of heat transfer \dot{Q}ᵢₙ.

In some embodiments, the trained model (11; 26) is or has been tested using a plurality of test data sets, each test data set comprising a value of setpoint temperature and a value of inside temperature Tₛᵢₜₑ at the site (2) and a value of position and a value of heat transfer \dot{Q}ᵢₙ. In some embodiments, the trained model (11; 26) is or has been tested using a plurality of test data sets, each test data set comprising a test value of setpoint temperature and a test value of inside temperature Tₛᵢₜₑ at the site (2) and a test value of position and a test value of heat transfer \dot{Q}ᵢₙ. A heat meter can, by way of non-limiting example, be used to estimate and/or to determine the (test) value of heat transfer \dot{Q}ᵢₙ.

The instant disclosure deals with any of the methods described above, the method further comprising using the calibrated model (11; 26) to estimate the heat transfer \dot{Q}_{in,est} via the one or more thermal energy exchangers (4-8) based on the value of setpoint temperature and based on the value of inside temperature Tₛᵢₜₑ at the site (2) and based on the value of position.

In some embodiments, the calibrated model (11; 26) uses one or more rectified linear unit functions to estimate the heat transfer \dot{Q}_{in,est} via the one or more thermal energy exchangers (4-8). Rectified linear unit functions mitigate issues due to vanishing gradients. Consequently, the model (11; 26) may perform its calculations using single precision variables rather than double precision variables as weights. The calibrated model (11; 26) then needs less memory.

The instant disclosure still deals with any method of the methods described above, the method further comprising: using the calibrated model (11; 26) to normalise the value of setpoint temperature; using the calibrated model (11; 26) to normalise the value of inside temperature Tₛᵢₜₑ at the site (2); using the calibrated model (11; 26) to normalise the value of position; and using the calibrated model (11; 26) to estimate the heat transfer \dot{Q}_{in,est} via the one or more thermal energy exchangers (4-8) based on the normalised value of setpoint temperature and based on the normalised value of inside temperature at the site (2) and based on the normalised value of position. A calibrated model (11; 26) working with normalised input values generally provides more accurate estimates of heat transfer \dot{Q}_{in,est}.

The present disclosure still deals with any method of the methods described above, the method further comprising: producing one or more individual values by producing an individual value from each signal indicative of a position of a valve; and producing the value of position by determining a mean of the one or more individual values.

The present disclosure also deals with any of the methods described above, the method further comprising: producing one or more individual values by producing an individual value from each signal indicative of a position of a valve; and producing the value of position by determining an arithmetic mean of the one or more individual values. In some embodiments, the arithmetic mean is a weighted arithmetic mean.

The instant disclosure still deals with any of the methods described above, the method further comprising: producing one or more individual values by producing an individual value from each signal indicative of a position of a valve; and producing the value of position by determining a geometric mean of the one or more individual values.

The present disclosure still further deals with any of the methods described above, the method further comprising: producing one or more individual values by producing an individual value from each signal indicative of a position of a valve; and producing the value of position by calculating an arithmetic mean of the one or more individual values. In some embodiments, the arithmetic mean is a weighted arithmetic mean.

The instant disclosure yet further deals with any of the methods described above, the method further comprising: producing one or more individual values by producing an individual value from each signal indicative of a position of a valve; and producing the value of position by calculating a geometric mean of the one or more individual values.

The present disclosure still deals with any method of the methods described above, the method further comprising using the calibrated model (11) to estimate the heat transfer \dot{Q}_{in,est} via the one or more thermal energy exchangers (4-8) exclusively as a function of the value of setpoint temperature and of the value of inside temperature Tₛᵢₜₑ at the site (2) and of the value of position. By limiting the number of input values of the calibrated model (11), the estimates apply to a plethora of sites (2). For example, not all sites (2) comprise outside temperature sensors. That is, estimates of heat transfer \dot{Q}_{in,est} via the one or more thermal energy exchangers (4-8) can also be provided for sites (2) having no outside temperature sensors.

The instant disclosure still deals with any method of the methods described above and involving normalised input values, the method further comprising using the calibrated model (11) to estimate the heat transfer \dot{Q}_{in,est} via the one or more thermal energy exchangers (4-8) exclusively as a function of the normalised value of setpoint temperature and of the normalised value of inside temperature at the site (2) and of the normalised value of position.

The present disclosure still deals with any method of the methods described above and involving an exclusive estimate of heat transfer \dot{Q}_{in,est}, the method further comprising: acquiring a signal indicative of an outside temperature outside the site (2); producing a value of outside temperature Tₒᵤₜ from the signal indicative of outside temperature; providing the calibrated model (26) with the value of setpoint temperature and with the value of inside temperature Tₛᵢₜₑ at the site (2) and with the value of position and with the value of outside temperature Tₒᵤₜ; and using the calibrated model (26) to estimate the heat transfer \dot{Q}_{in,est} via the one or more thermal energy exchangers (4-8) based on the value of setpoint temperature and based on the value of inside temperature Tₛᵢₜₑ at the site (2) and based on the value of position and based on the value of outside temperature Tₒᵤₜ

The instant disclosure still deals with any method of the methods described above and involving a value of outside temperature Tₒᵤₜ, the method further comprising acquiring the signal indicative of the outside temperature outside the site (2) by reading the signal indicative of outside temperature from a sensor outside the site (2).

In some embodiments, the sensor outside the site (2) comprises a temperature sensor. In some embodiments, the sensor outside the site (2) is a temperature sensor. In some embodiments, the sensor outside the site (2) comprises a thermocouple. In some embodiments, the sensor outside the site (2) is a thermocouple. A thermocouple can allow reuse of an existing or legacy thermocouple of an outside unit such as an outside manufacturing plant. In some embodiments, the sensor outside the site (2) comprises a thermistor. In some embodiments, the sensor outside the site (2) is a thermistor. A thermistor can allow reuse of an existing or legacy thermistor of an outside unit such as an outside fan coil unit. In some embodiments, the sensor outside the site (2) comprises a fibre optic sensor. In some embodiments, the sensor outside the site (2) is a fibre optic sensor. Fibre optic sensors provide benefits in hazardous environments.

The instant disclosure still deals with any method of the methods described above and involving a value of outside temperature Tₒᵤₜ and not involving a temperature sensor, the method further comprising acquiring the signal indicative of the outside temperature outside the site (2) by connecting to a computer network and by receiving from the network a data package comprising the signal indicative of the outside temperature and by extracting the signal indicative of the outside temperature from the data package.

The present disclosure also deals with any of the methods described above involving an outside temperature, the method further comprising acquiring the signal indicative of the outside temperature outside the site (2) by connecting to a network of interconnected computers and by receiving from the network a data package comprising the signal indicative of the outside temperature and by extracting the signal indicative of the outside temperature from the data package. The system can dispense with an outside temperature sensor if a signal indicative outside temperature is provided by an internet service provider.

The present disclosure still deals with any method of the methods described above and involving a value of outside temperature Tₒᵤₜ, the method further comprising: using the calibrated model (26) to normalise the value of setpoint temperature; using the calibrated model (26) to normalise the value of inside temperature Tₛᵢₜₑ at the site (2); using the calibrated model (26) to normalise the value of position; using the calibrated model (26) to normalise the value of outside temperature Tₒᵤₜ; and using the calibrated model (26) to estimate the heat transfer \dot{Q}_{in,est} via the one or more thermal energy exchangers (4-8) based on the normalised value of setpoint temperature and based on the normalised value of inside temperature at the site (2) and based on the normalised value of position and based on the normalised value of outside temperature. A calibrated model (26) working with normalised input values generally provides more accurate estimates of heat transfer \dot{Q}_{in,est}.

The instant disclosure still deals with any method of the methods described above and involving a value of outside temperature Tₒᵤₜ, the method further comprising using the calibrated model (26) to estimate the heat transfer \dot{Q}_{in,est} via the one or more thermal energy exchangers (4-8) exclusively as a function of the value of setpoint temperature and of the value of inside temperature Tₛᵢₜₑ at the site (2) and of the value of position and of the value of outside temperature Tₒᵤₜ By limiting the number of input values of the calibrated model (26), the estimates apply to a greater number of sites (2). For example, information about the residential or industrial or commercial purpose of a site (2) is not always available. That is, estimates of heat transfer \dot{Q}_{in,est} via the one or more thermal energy exchangers (4-8) can also be provided absent any knowledge of the purpose of the site (2).

The present disclosure still deals with any method of the methods described above and involving a normalised value of outside temperature Tₒᵤₜ, the method further comprising using the calibrated model (26) to estimate the heat transfer \dot{Q}_{in,est} via the one or more thermal energy exchangers (4-8) exclusively as a function of the normalised value of setpoint temperature and of the normalised value of inside temperature at the site (2) and of the normalised value of position and of the normalised value of outside temperature.

The instant disclosure still deals with any method of the methods described above, the method further comprising: comparing the estimated heat transfer \dot{Q}_{in,est} to an upper threshold; and if the estimated heat transfer \dot{Q}_{in,est} is larger than the upper threshold, operating an electric switch to curtail power to a system for heating and/or ventilation and/or air-conditioning (1).

The present disclosure still deals with any method of the methods described above and involving an electric switch, wherein the electric switch connects the system for heating and/or ventilation and/or air-conditioning (1) to a power grid, the method further comprising, if the estimated heat transfer \dot{Q}_{in,est} is larger than the upper threshold, disconnecting the system for heating and/or ventilation and/or air-conditioning (1) from the power grid by operating the electric switch. Curtailment of power otherwise delivered to a system for heating and/or ventilation and/or air-conditioning (1) protects the power grid from excessive demand. Any adverse influences of excessive demand caused by the system for heating and/or ventilation and/or air-conditioning (1) on the stability of the grid are mitigated thereby.

The instant disclosure still deals with a device comprising a first interface for acquiring a signal indicative of a setpoint temperature, a second interface for acquiring a signal indicative of an inside temperature at a site (2), a third interface for acquiring one or more signals indicative of positions of valves of one or more thermal energy exchangers (4-8), a memory and a processor in operative communication with the memory, with the first interface, with the second interface, and with the third interface, the processor configured to: read a calibrated model (11; 26) from the memory; and perform one or more of the methods as described herein.

The present disclosure also deals with a device comprising a first interface for acquiring a signal indicative of a setpoint temperature, a second interface for acquiring a signal indicative of an inside temperature at a site (2), a third interface for acquiring one or more signals indicative of positions of valves of one or more thermal energy exchangers (4-8), a memory and a processor in operative communication with the memory, with the first interface, with the second interface, and with the third interface, the processor configured to: read the calibrated model (11) from the memory; and perform one or more of the methods of estimating a heat transfer \dot{Q}_{in,est} as described above while not involving an outside temperature and not involving an electric switch to curtail power.

The instant disclosure still deals with a device comprising a first interface for acquiring a signal indicative of a setpoint temperature, a second interface for acquiring a signal indicative of an inside temperature at a site (2), a third interface for acquiring one or more signals indicative of positions of valves of one or more thermal energy exchangers (4-8), a fourth interface for acquiring a signal indicative of an outside temperature outside the site (2), a memory and a processor in operative communication with the memory, with the first interface, with the second interface, with the third interface, and with the fourth interface, the processor configured to: read the calibrated model (26) from the memory; and perform one or more of the methods as described above involving an outside temperature while not involving an electric switch to curtail power.

The present disclosure still further deals with a device comprising a first interface for acquiring a signal indicative of a setpoint temperature, a second interface for acquiring a signal indicative of an inside temperature at a site (2), a third interface for acquiring one or more signals indicative of positions of valves of one or more thermal energy exchangers (4-8), a fifth interface for operating an electric switch, a memory and a processor in operative communication with the memory, with the first interface, with the second interface, with the third interface, and with the fifth interface, the processor configured to: read the calibrated model (11) from the memory; and perform one or more of the methods of the present disclosure, the method involving operating an electric switch to curtail power while not involving an outside temperature.

The instant disclosure yet further deals with a device comprising a first interface for acquiring a signal indicative of a setpoint temperature, a second interface for acquiring a signal indicative of an inside temperature at a site (2), a third interface for acquiring one or more signals indicative of positions of valves of one or more thermal energy exchangers (4-8), a fourth interface for acquiring a signal indicative of an outside temperature outside the site (2), a fifth interface for operating an electric switch, a memory and a processor in operative communication with the memory, with the first interface, with the second interface, with the third interface, with the fourth interface, and with the fifth interface, the processor configured to: read a calibrated model (11; 26) from the memory; and perform one or more of the methods of the present disclosure involving operating an electric switch to curtail power.

In some embodiments, the devices of the instant disclosure perform their methods using the calibrated models (11; 26) as read from the memories.

The present disclosure also pertains to any of the devices of the present disclosure, wherein the memory has a capacity of one mebibyte or less. This means that the calibrated model (11, 26) can be stored in a memory having a capacity of one mebibyte or less. The system thus relies on modest computational resources to estimate the heat transfer \dot{Q}_{in,est} via the one or more thermal energy exchangers (4-8).

The first, second, third, fourth, and fifth interfaces need not be mutually different. For example, the same interface may read an inside temperature and read an outside temperature.

The instant disclosure also pertains to a computer program comprising a set of instructions that when executed by one or more processors cause any of the devices as described above to perform one or more of the methods as described herein.

The present disclosure also deals with a computer program comprising a set of instructions that when executed by the processor of a device of the present disclosure cause the device to perform one or more methods incorporating teachings of the present disclosure.

The instant disclosure still further deals with a computer program product comprising a set of instructions that when executed by the processor of a device of the instant disclosure cause the device to perform one or more of the methods incorporating teachings of the instant disclosure.

The instant disclosure also deals with a computer-readable medium having stored thereon any of the computer programs of the instant disclosure. The present disclosure also deals with a computer-readable medium having stored thereon any of the computer program products of the present disclosure.

The instant disclosure also pertains to any computer-readable medium of the computer-readable media of the instant disclosure, wherein the computer-readable medium has a capacity of one mebibyte or less. This means that the instructions for estimating heat transfer \dot{Q}_{in,est} can be stored on a computer-readable medium having a capacity of one mebibyte or less. The system thus relies on modest computational resources to estimate the heat transfer \dot{Q}_{in,est} via the one or more thermal energy exchangers (4-8).

It should be understood that the foregoing relates only to certain embodiments of the disclosure. Numerous changes can be made therein without departing from the scope of the disclosure as defined by the following claims. It should also be understood that the disclosure is not restricted to the illustrated embodiments and that various modifications can be made within the scope of the claims.

### REFERENCE NUMERALS

1 system for heating and/or ventilation and/or air-conditioning
2 site such as a building
3 system controller
4-8 terminal units such as thermal energy exchangers
9 arrow indicative of power intake
10 arrow indicative of power loss
11 neural network
12-14 input nodes
15 hidden layer
16-19 nodes
20 hidden layer
21-24 nodes
25 output node
26 neural network
27-30 input nodes
31 hidden layer
32-35 nodes
36 hidden layer
37-40 nodes
41 output node

1. A method of estimating a heat transfer via one or more thermal energy exchangers, the method comprising:
acquiring a signal indicative of a setpoint temperature;
acquiring a signal indicative of an inside temperature at a site;
acquiring one or more signals indicative of positions of valves of the one or more thermal energy exchangers;
producing a value of setpoint temperature from the signal indicative of the setpoint temperature;
producing a value of inside temperature at the site from the signal indicative of inside temperature;
producing a value of position from the one or more signals indicative of positions of the valves;
providing a calibrated model with the value of setpoint temperature and with the value of inside temperature at the site and with the value of position; and
using the calibrated model to estimate the heat transfer via the one or more thermal energy exchangers.

2. The method according to claim 1, further comprising:
using the calibrated model to normalise the value of setpoint temperature;
using the calibrated model to normalise the value of inside temperature at the site (2);
using the calibrated model to normalise the value of position; and
using the calibrated model to estimate the heat transfer via the one or more thermal energy exchangers based on the normalised value of setpoint temperature and the normalised value of inside temperature at the site and the normalised value of position.

3. The method according to claim 1, further comprising:
producing one or more individual values by producing an individual value from each signal indicative of a position of a valve; and
producing the value of position by determining a mean of the one or more individual values.

4. The method according to claim 2, further comprising using the calibrated model to estimate the heat transfer via the one or more thermal energy exchangers exclusively as a function of the normalised value of setpoint temperature and the normalised value of inside temperature at the site and the normalised value of position.

5. The method according to claim 1, further comprising:
acquiring a signal indicative of an outside temperature outside the site;
producing a value of outside temperature from the signal indicative of outside temperature;
providing the calibrated model with the value of setpoint temperature and with the value of inside temperature at the site and with the value of position and with the value of outside temperature; and
using the calibrated model to estimate the heat transfer via the one or more thermal energy exchangers based on the value of setpoint temperature and the value of inside temperature at the site and the value of position and the value of outside temperature.

6. The method according to claim 5, further comprising acquiring the signal indicative of the outside temperature outside the site by reading the signal indicative of outside temperature from a sensor outside the site.

7. The method according to claim 5, further comprising acquiring the signal indicative of the outside temperature outside the site by connecting to a computer network and by receiving from the network a data package comprising the signal indicative of the outside temperature and by extracting the signal indicative of the outside temperature from the data package.

8. The method according to claim 5, further comprising:
using the calibrated model to normalise the value of setpoint temperature;
using the calibrated model to normalise the value of inside temperature at the site;
using the calibrated model to normalise the value of position;
using the calibrated model to normalise the value of outside temperature; and
using the calibrated model to estimate the heat transfer via the one or more thermal energy exchangers based on the normalised value of setpoint temperature and the normalised value of inside temperature at the site and the normalised value of position and the normalised value of outside temperature.

9. The method according to claim 5, further comprising using the calibrated model to estimate the heat transfer via the one or more thermal energy exchangers exclusively as a function of the value of setpoint temperature and the value of inside temperature at the site and the value of position and of the value of outside temperature.

10. The method according to claim 8, further comprising using the calibrated model to estimate the heat transfer via the one or more thermal energy exchangers exclusively as a function of the normalised value of setpoint temperature and the normalised value of inside temperature at the site and the normalised value of position and the normalised value of outside temperature.

11. The method according to claim 1, further comprising:
comparing the estimated heat transfer to an upper threshold; and
if the estimated heat transfer is larger than the upper threshold, operating an electric switch to curtail power to a system for heating and/or ventilation and/or air-conditioning.

12. The method according to claim 11, wherein the electric switch connects the system for heating and/or ventilation and/or air-conditioning to a power grid; and
the method further comprises, if the estimated heat transfer is larger than the upper threshold, disconnecting the system for heating and/or ventilation and/or air-conditioning from the power grid by operating the electric switch.

13. A device comprising:
a first interface for acquiring a signal indicative of a setpoint temperature;
a second interface for acquiring a signal indicative of an inside temperature at a site;
a third interface for acquiring one or more signals indicative of positions of valves of one or more thermal energy exchangers;
a memory; and
a processor in operative communication with the memory, the first interface, the second interface, and the third interface, the processor programmed to:
read a calibrated model from the memory; and
acquire a signal indicative of a setpoint temperature;
acquire a signal indicative of an inside temperature at a site;
acquire one or more signals indicative of positions of valves of one or more thermal energy exchangers;
produce a value of setpoint temperature from the signal indicative of the setpoint temperature;
produce a value of inside temperature at the site from the signal indicative of inside temperature;
produce a value of position from the one or more signals indicative of positions of the valves;
provide a calibrated model with the value of setpoint temperature and with the value of inside temperature at the site and with the value of position; and
use the calibrated model to estimate the heat transfer via the one or more thermal energy exchangers.
